(19) United States
(12) Patent Application Publication
(10) Pub. No.: US 2024/0277185 A1
(43) Pub. Date: Aug. 22, 2024

(54) DEVICE, SYSTEM AND METHOD FOR FILTRATION AT THE NANOSCALE FOR FRYERS, THE FILTRATION COMPRISING CROSSFLOW MEMBRANE FILTRATION AT A HIGH-PRESSURE RANGE

(71) Applicant: Gastrofrit AG, Rorschach (CH)

(72) Inventors: Alexander SCHLEGEL, Arbon (CH); Philippe GEIGER, Luzern (CH); Jürg BUCHLI, Brunnen (CH); Nadina MÜLLER, Uerikon (CH)

(21) Appl. No.: 17/799,731

(22) PCT Filed: Feb. 15, 2021
(86) PCT No.: PCT/IB2021/051236

§ 371 Date: Aug. 15, 2022

Related U.S. Application Data
(60) Provisional application No. 62/976,432, filed on Feb. 14, 2020.

(51) Int. Cl. A47J 37/12; B01D 35/26

(52) U.S. Cl. CPC A47J 37/1223; B01D 35/26; B01D 2201/182

(57) ABSTRACT

A deep fryer device, the deep fryer device comprising an enclosure delimited by outer walls and a container suitable for containing a liquid, the liquid being preferably an oil, the deep fryer being connected to a filtration system, the filtration system is configured to receive continuously a flow of the liquid in a closed loop configuration, the filtration system comprising a filter element, wherein the filter element is a membrane filter.

### CROSS REFERENCE TO RELATED APPLICATIONS

This application claims the benefit of U.S. Provisional Application No. 62/976,432, filed Feb. 14, 2020, the contents of which are expressly incorporated herein by reference in their entirety and used to define the features for which protection may be claimed hereby, it being understood that the entirety thereof will contribute to the solution of the technical problem underlying the invention, some features of which may be mentioned herein being of particular significance.

### Identification of the Parties Concerned

The applicant in the present IP case is Gastrofrit AG of Switzerland. The inventor(s) of the invention described in this patent specification are Alexander Schlegel of Switzerland, Philippe Geiger of Switzerland and Germany, Jürg Buchli of Switzerland, and Nadina Müller of Switzerland. At the time of filing, John B. Moetteli and Da Vinci Partners LLC of Switzerland represent the applicant.

### Copyright & Legal Notice

A portion of the disclosure of this patent document contains material which is subject to copyright protection. The Applicant has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### BACKGROUND OF THE INVENTION

The life of frying oil is limited. 60% of used frying oil must be disposed of due to complex chemical and physical reactions that occur during the frying process.

The use of membrane filtration systems and equipment is proposed here for the continuous purification of frying oil in a commercial fryer, such as those used in the food service industry, to minimize oil waste. Membrane filtration findings from testing and literature, as well as data generated for scale-up, were summarized in the detailed description of this application.

The operation of membranes is described, for example, in the article “Einführung in Theorie und Praxis der Membrantechnik” by Dr. Peter Schirg, the contents of which are expressly incorporated herein by reference in their entirety and used to define the features for which protection may be claimed hereby.

In the catering industry, despite various treatment and filtration processes, considerable quantities of frying oil have to be disposed of. The chemical and sensory deterioration of the oil is due to complex degradation and reaction processes that take place during frying and under the influence of heat and lead to the deterioration of the oil. Extending the life of frying oil could therefore lead to significant resource savings.

### SUMMARY OF THE INVENTION

A frying system and method/apparatus are provided, wherein the frying device comprises an enclosure (i.e., housing) bounded by exterior walls and a container adapted to receive a liquid, the liquid preferably being an oil, and the frying device is connected to a filtration system. The filtration system is configured to continuously receive a flow of the fluid in a tap loop configuration. The filtration system has a filter element, wherein the filter element is a membrane filter.

This invention is concerned with the task of developing a deep-fat fryer for system catering which guarantees deep-frying oil of consistently good quality within the tolerable limits. The disposal of used frying oil could thus be significantly reduced.

To achieve this goal, applications and processes from the food industry were considered for the treatment of the frying oil. Various works were carried out on membrane filtration, depth filtration and fractionation, and the addition of natural antioxidants was studied and evaluated. The results indicated that membrane filtration is the most suitable for extending the life of frying oil without the use of additives (such as antioxidants).

### BRIEF DESCRIPTION OF THE DRAWINGS

The attached drawings represent, by way of example, different embodiments of the subject of the invention.

FIG. 1 schematically shows the mass and heat transfer that takes place within the fried food during deep-frying.

FIG. 2 shows membrane processes: Microfiltration (MF), ultrafiltration (UF), nanofiltration (NF) and reverse osmosis (UO).

FIG. 3 shows the illustration of the principle of cross-flow filtration.

FIG. 4 shows a possible flow in the design of a membrane system.

FIG. 5 shows a three-dimensional color body.

FIGS. 6A and 6B show the test unit TestUnit M20 from Alfa Laval.

FIG. 7 shows the structure of the individual plate module components.

FIG. 8 shows a schematic of the heat exchanger with a filling volume of 7.6 liters and four scrapers.

FIG. 9 shows the second basin, which serves as a prototype fryer and is connected to the adapted membrane test unit M20.

FIG. 10 shows the labeling of the specimen containers.

FIG. 11 shows mass flows.

FIG. 12 schematically shows the experimental setup.

FIG. 13 shows the course of an experimental day, which is divided into two parts.

FIG. 14 shows a risk matrix.

FIG. 15 shows the measurement results of the four temperature probes and the humidity as a function of time.

FIG. 16 shows the measured masses and TPA values.

FIG. 17 shows the results of the preliminary membrane selection tests.

FIG. 18 shows that permeate flux decreases as TPAR increases.

FIG. 19 shows the change in the retention factor.

FIG. 20 shows that the retention factor as well as the permeate flux increase with an increase in pressure.

FIG. 21 shows that the highest permeate flux is measured at 3.12 l/h·m² at a temperature of 90° C.

FIG. 22 shows that the volume flow rate slightly influences the permeate flux.

FIG. 23 shows the permeate flux in relation to the TPAR in the long-term test.

FIG. 24 shows the change in the retention factor.

FIG. 25 shows the course of the viscosity.

FIG. 26 shows the process sketch of the fryer according to the invention.

FIG. 27 shows an overview of the relationships established.

FIG. 28 shows a section of the simulation.

FIG. 29 shows the influence of the membrane area on the TPA curve in the fryer.

FIG. 30 shows the TPA values of the prototype over the entire course.

FIG. 31 shows the acid numbers of the measured frying oil samples of standard and prototype as a function of transit time.

FIG. 32 shows the course of the anisidine number of standard and prototype over the course of the experimental time.

FIG. 33 shows PTG values.

FIG. 34 shows DEGLEV values.

FIG. 35 shows the course of the permeate flux during the frying test.

FIG. 36 shows viscosity values of the standard, prototype and retentate samples.

FIG. 37 shows data on the fab difference.

FIG. 38 shows the browning index of standard, prototype and retentate.

FIG. 39 shows the perceived color intensities from the standard fryer and the prototype.

FIG. 40 shows the evaluation of olfactory rancidity in the descriptive in-out test of the oils of standard fryer and prototype.

FIG. 41 shows that the frying oil of the prototype is initially perceived as fishy.

FIG. 42 shows the olfactory perception of the frying oils on the seventh day of the experiment.

FIG. 43 shows the evaluation of the gold-brown coloration in the descriptive in-out test of the French fries from the standard fryer and prototype.

FIG. 44 shows information about the attribute Roasty.

FIG. 45 shows the simulation settings when comparing continuous and batch oil drain.

Those skilled in the art will appreciate that elements in the Figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended to distinguish between similar elements and not necessarily for describing a sequential or chronological order. Moreover, relative terms like ‘front’, ‘back’, ‘top’ and ‘bottom’, and the like in the Description and/or in the claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENT

The following description is not intended to limit the scope of the invention in any way as it is exemplary in nature, serving to describe the best mode of the invention known to the inventors as of the filing date hereof. Consequently, changes may be made in the arrangement and/or function of any of the elements described in the exemplary embodiments disclosed herein without departing from the spirit and scope of the invention.

Primarily two membrane types were tested and characterized, the PERVAP 4060 from DeltaMem AG and the GMT oNF-3 from GMT Membrantechnik GmbH. The membrane filtration tests were carried out with an Alfa Laval TestUnit M20.

A continuous filtration system with integrated membrane filtration in a fryer was developed to evaluate the effects of continuous membrane filtration on oil degradation and to identify the critical parameters in the system. In addition, the process was simulated using a simulation model. The prototype was built based on an F2-300 deep fryer from Gastrofrit AG and the TestUnit M20 and was subjected to a frying test over 13 days. During this frying test, French fries and chicken nuggets were fried for six hours a day and five samples of frying oil were analyzed each day.

Oil quality was evaluated using spoilage indicators. These included: total polar fraction (TPA), acid number (SZ), anisidine number, and polymeric triglycerides (PTG) as determined by Fourier transform near-infrared spectroscopy (FT-NIR). The viscosity and color of the frying oils were measured by viscometers and spectrophotometers, respectively. In addition, a sensory in-out test was performed during the frying experiments.

Based on the results of the membrane characterization, the GMT oNF-3 type proved to be the most suitable membrane for the frying process. The GMT oNF-3 type achieved the optimum filtration efficiency at the following process parameters: transmembrane pressure (TMP): 25 bar, overflow: 151/min, oil temperature: 80° C., TPA in retentate (TPAR): <45%. The highest permeate flow at 80° C. oil temperature was 2.42 l/h·m². The retention factor ranged from 0.5 to 0.6 and depends on the TPA concentration in the retentate. The above parameters and the Reynolds number should be considered in a future scale-up of the system.

The simulated results of the frying test disproved the assumption that a constant oil quality can be achieved with a high permeate flux. It was shown that the limiting factor of the system is the retention factor of the membrane, as this directly influences the TPA concentration in the filtrate with increasing TPAR.

During the frying test with the prototype, several weaknesses of the system became apparent. The pumps and valves were very susceptible to solid particles. Prefiltration was therefore essential to ensure proper operation. However, it was found that the degradation of the frying oil slowed down significantly with the prototype. In one particular test run, the prototype maintained the frying oil at a TPA content of 11.84% even after 13 days (312 hours) of frying. In comparison, the standard fryer exceeded the legal maximum of 27% TPA after 295 hours. Color measurements also showed that at the end of the test series, there was a significant color difference of ΔE*ab=43.83 between oil from the standard fryer and the prototype. The permeate flow rate at the beginning of a specific test was 2.18 l/h·m², which decreased during the test and settled between 1.00 and 1.20 l/h·m². The sensory in-out test showed no abnormalities in either fryer that would negatively affect the food product.

Systems and devices according to the present invention show that a significant extension of frying oil life can be achieved. Criteria such as membrane area, frying oil temperature in the membrane circuit, Reynolds number, transmembrane pressure (TMP), and the number of solid particles in the frying oil must be considered to define and implement a membrane system design specifically for fryer conditions. The number of solid particles in the frying oil must be reduced by prefiltration to avoid clogging-related disturbances in the system.

In one embodiment of a deep fryer, the deep fryer is equipped with an appropriately sized membrane filtration system connected in a closed circuit. In summary, the present invention provides an environmentally friendly, innovative and customer-oriented product that exceeds customer expectations and enables simple, safe and cost-effective deep-frying.

The invention showed that prefiltration by means of depth filters could well have a positive effect on the spoilage process of frying oil and should therefore be pursued further.

### 1. Theory

Based on the initial situation described in the introduction, five main topics emerge whose theoretical foundations are highlighted in this section. These include the frying process, filtration, fractionation of oil, and the definition of scale-up and how this can be applied to the development of a membrane system. In addition, the theoretical basis for the analytics used will be explained.

### 1.1 Basics of the Frying Process

The deep-frying process is characterized by the rapid preparation of flavourful foods. Over the years, interest in optimizing this complex frying process has grown. This has led to a better understanding of the entire process, from the frying oil to the products to the fryer and the general frying conditions. Deep frying involves exposing food to temperatures of 140-180° C. and cooking it in cooking oil. In addition to the cooking of the food during the frying process, the frying oil also is exposed to a wide variety of chemical and physical processes. In the following section, the chemical and physical reactions and changes that take place during the deep-frying process in the product, but also in the deep-frying medium, are discussed.

### 1.1.1 Mass and Heat Transfer During Frying

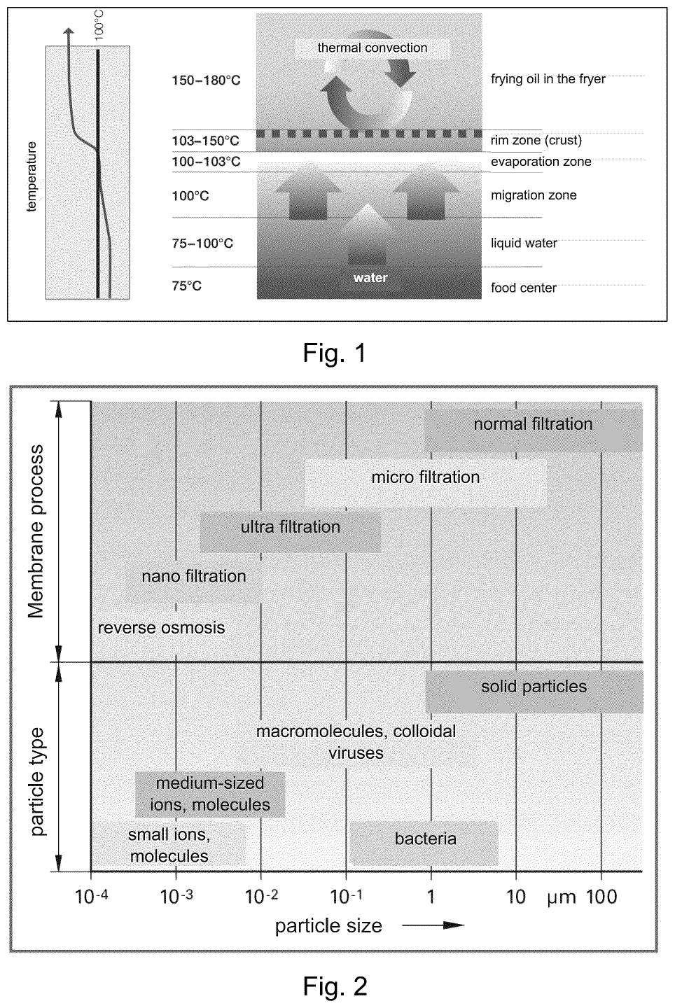

FIG. 1 schematically shows the mass and heat transfer that takes place within the fried product during deep-frying. Only a few seconds after the product is immersed in the deep-frying fat, a thin crust is formed in an initial phase, the structure of which has a decisive influence on the further deep-frying process and on the quality and crispiness. During this process, a mass transfer takes place due to the evaporation of the water at the edge zone. The water bound in the food penetrates to the outside and is released to the frying oil. During this phase, the temperature does not rise above 100° C. The evaporating water in the frying oil causes bubble formation, which increases the contact area between air and frying oil, thus accelerating the heat transfer rate between frying oil and air, as well as the oxidative degradation of the frying oil. This bubbling can be reduced by lowering the temperature, reducing the amount of fried product, or pre-drying the food. In this way, the steam can have a protective effect on the frying oil by forming a layer of steam over it, preventing contact with oxygen. As long as the evaporation of water is faster than the ability of the surrounding frying oil to remove the steam by convection, the rate of heat transfer from oil to food surface is zero. Water transport ensures that the outer layer of the food is cooled and thus does not burn. Only when no water is carried from the inside of the food to the surface layer does the temperature rise from the outside to the inside. The mass transfer of oil absorption occurs in the opposite direction to the evaporating water, but most of the oil absorption occurs outside the frying medium as the food cools. Cooling creates a vacuum in the pores of the food, allowing frying oil to be readily absorbed by the food surface.

### 1.1.2 Chemical and Physical Changes of the Frying Medium

The type and rate of formation of degradation products in frying oil depend, among other things, on the composition of the frying oil (fatty acid pattern, content of unsaponifiable), the type of frying (intermittent or continuous), the applied frying temperature, the duration of the frying process and the type of fried food. The increase in total polar fraction (TPA), acidity, di- and polymeric triglycerides (DPTG) and darkening color are typical indications of frying oil degradation at elevated temperatures. Oxidation of unsaturated fatty acids leads to volatile short fragments (C6, C7) and non-volatile, oxidized, monomeric TAG fragments.

### 1.1.3 Changes in the Frying Material

Basically, a distinction can be made between desirable and undesirable changes in the fried food. Starch gelatinization and protein denaturation are changes that contribute to improvements in the digestibility and palatability of the food. Furthermore, the Maillard reaction is necessary for the browning of the food and the formation of flavour components and is therefore desirable. Among the undesirable changes is the fat absorption. This is strongly dependent on the ratio of the surface area of the fried food to its mass. In the case of potato chips, the frying oil absorption due to deep-frying is 30-40%, while for French fries it is 6-12%. Although too high a fat intake is negative, a certain fat intake is essential for the sensory quality of some products. This leads to the conclusion that the frying oil, which is absorbed by the product, must be of sensory quality in order to produce a qualitatively flawless product. As with frying, baking, grilling or roasting, the formation of carcinogenic acrylamide can occur during the deep-frying of starchy and water-poor foods, which also contain protein components such as asparagine and reducing sugars.

### 1.2 Filtration

In filtration, a liquid with suspended particles is passed through a porous medium. The suspended particles are retained and a clear filtrate is produced. The types of filtration can be divided into cake-forming filtration, depth filtration or membrane filtration, depending on how the particles are retained.

### 1.2.1 Depth Filtration

Depth filtration usually takes place in a relatively thick filter medium layer of 3-6 mm. This can consist of fibres or even grains. The particles to be removed are removed from the liquid by physical-chemical mechanisms that cause the particles to be retained as they penetrate the filter layer. Settling of particle agglomerates on the surface of the filter layer is undesirable, as this impedes further entry of particles into the depth filter, causing a loss of pressure. Various termination criteria can be defined for the filtration process, at which filtration must be stopped and the filter cleaned or replaced. Possible termination criteria are: Reaching the maximum pressure drop, insufficient filtration quality (filtrate is not clear) or insufficient volume flow. Adhesion of particles to the filter medium takes place by electrostatic and van der Waals forces. Therefore, it can be influenced with additives that change the interaction potential of the individual adhesive partners. This is possible, for example, with a change in the pH value. In this way, particles smaller than the pore size of the filter can also be deposited.

Depth filters with electrostatic binding are particularly suitable for fast filtration. Depth filters are used as cartridge, fibre and sand filters. Since the solid is fixed to the filter medium, it must be separated from it again or disposed of with it. If the concentration of solids is very high, the depth filtration process is not effective.

### 1.2.2 Membrane Filtration

Today, membrane technology is used in a wide variety of applications in the food industry. Most of these applications are pressure-driven membrane processes. These include the membrane processes shown in FIG. 2: Microfiltration (MF), Ultrafiltration (UF), Nanofiltration (NF) and Reverse Osmosis (RO).

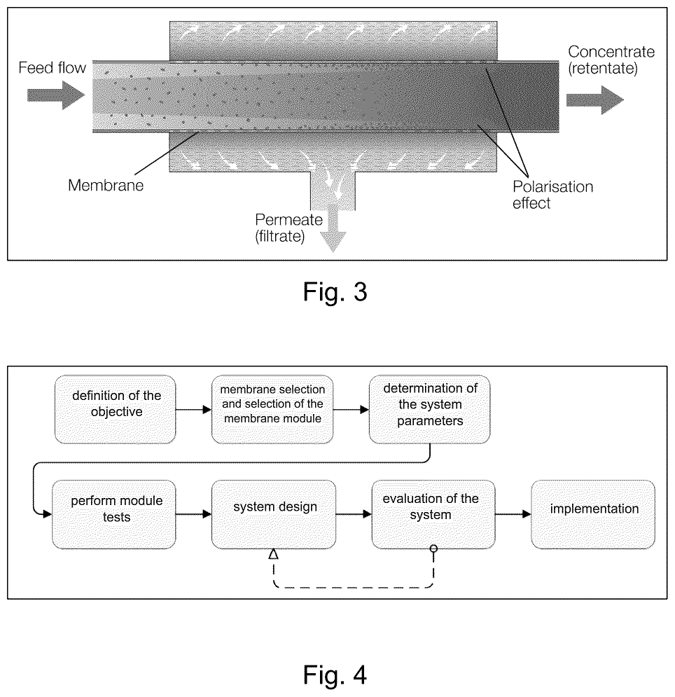

The membrane separation process is mostly used to separate a solvent, macromolecules or small suspended particles from a liquid. The distinguishing criteria are not only the size and surface properties of the molecules, but also, albeit to a lesser extent, the physical and chemical properties of the membranes. Thin, semi-permeable membranes are used, which exhibit selective permeability. Solvents and small molecules generally permeate the membranes, but macromolecules or suspended solids are retained by the membranes. The product that permeates the membrane is called permeate and the retained portion is called retentate. The product feed or the medium to be filtered is usually referred to as the feed. Membrane filtration is ideally carried out in a cross-flow circuit and is shown schematically in FIG. 3. FIG. 3 shows the principle of cross-flow filtration. The product flows from left to right across the membrane, with the permeate passing through the membrane and flowing off. This results in concentration of the retentate.

The transmembrane pressure (TMP) is considered the driving force of membrane filtration and is defined as the difference between the pressure on the retentate side and the pressure on the permeate side (normally ambient pressure). Since there is a pressure drop due to the feed flow, the average pressure of the inlet pressure before the membrane and the outlet pressure after the membrane is used to calculate the TMP. The lower this pressure drop, the better the filtration.

In the design of membrane processes, there are two basic factors that index the performance of filtration. One is flux and the other is selectivity. Flux is defined as the volume of permeate passing through the membrane per unit of time and area (e.g. liters/m²·h). It depends on the membrane, the application as well as the operating conditions and is usually a function of time. Selectivity is generally described as retention of specific substances and is described by the retention factor R. The factor R is dimensionless and varies between 0% (no retention) and 100% (complete retention of the solute).

The permeate flux and the retention factor depend on the properties of the medium to be filtered and the suspended particles as well as the membrane properties. The membrane properties are determined by the pore size, pore size distribution, the curvature of the flow path of the liquid and particles across the membrane surface, the membrane thickness and the pore shape.

As the product flows through the membrane, the concentration of solids in the vicinity of the membrane increases. This creates a concentration gradient that can negatively affect permeate flux. This is also known as concentration polarization. Concentration polarization increases as an expression of the ratio of concentration at the membrane surface and in the main stream as transmembrane pressure and boundary layer thickness increase. The concentration at the membrane surface increases with increasing permeate flux.

In cross-flow filtration, the drop in permeate flux as a result of concentration polarization can be counteracted by increasing the flow velocity. If no suspended solids are present that cause deposits, the permeate flux behaves constantly. The flux is constant if the flow velocities at the membrane surface, the solids concentration in the feed and the transmembrane pressure are also constant. If a flux drop occurs despite constant conditions, this can be attributed to fouling, i.e. fouling by deposits on the membrane surface.

A high flow velocity usually causes permeate flux to be favored. However, this also leads to a pressure drop over the length of the membrane modules connected in series. In addition, the increase in volume flow and pressure drop also increases the energy input and thus the costs. Optimization of the overflow velocity is therefore important to ensure the economic efficiency of a membrane process.

To improve the filter quality and to avoid process disturbances, pre-treatment of the medium to be filtered is recommended. The medium to be filtered may contain suspended solids such as fibres or organic or inorganic particles. If these are not removed prior to the membrane filtration process, they can deposit on the membrane surface, causing clogging in the system, which in turn leads to a pressure loss across the membrane and thus increased fouling. The following pre-treatments are typically used:
Removal of coarse particles with a coarse sieve
Clarifying whether with or without flocculation
Reduction of alkalinity through pH adjustment
Reduction of free chlorine by sodium disulfate or activated carbon filter These serve as protection against fouling and inconsistencies during filtration and allow for improved performance and longer membrane life.

### 1.2.2.1 Membrane Types

A wide variety of membrane types are available for membrane filtration. Membranes can be either isotropic or anisotropic. Isotropic membranes have uniform pores across their thickness. Anisotropic membranes, on the other hand, consist of a support layer on which a thin, semi-permeable material makes up the surface. Microfiltration (MF) membranes are usually isotropic. In ultrafiltration (UF), nanofiltration (NF) and reverse osmosis (UO), anisotropic membranes are generally used.

Typical characteristics of various membrane modules are summarized in Table 1.

TABLE 1
Typical characteristics of different membrane modules such as spiral wound, plate, hollow fibre and
tube modules. The mentioned membrane modules are mostly available with different pore sizes. Microfiltration
(MF) usually has a pore size of 0.1-10 μm. Other common pore sizes are: Ultrafiltration (UF) 0.01-
0.1 μm, Nanofiltration (NF) 0.001-0.01 μm and Reverse Osmosis requires a pore size of >0.001 μm:

| | Spiral winding | Plate and | Hollow fibre | Tube module | |
|---|---|---|---|---|---|
| | module | Frame module | module | Polymer | Ceramics |
| Pore size | MF, UF, NF, UO | MF, UF, NF, UO | MF, UF, NF, UO | MF, UF, NF, UO | MF, UF, NF |
| Materials | Polymers (large | Polymers (large | Polymers (lower | Al₂O₃, ZrO², | Al₂O₃, ZrO₂, |
| | Selection) | Selection) | Selection) | TiO₂, | TiO₂, |
| | | | | Carbon | Carbon |
| Costs | Deep | High | Medium | Medium | Very high |
| Space requirement | Deep | Medium - High | Medium | Medium - High | High |
| Sensitivity to | High | Medium | High | Deep | Deep |
| suspended solids in | | | | | |
| the feed | | | | | |
| Permissible viscosity | Medium | High | Deep | High | High |
| Temperature | Low - Medium | Medium | Low - Medium | Deep | Very high |
| resistance | | | | | |
| Backwashability | No | No | Yes | Yes | Yes |
| Fouling resistance | Medium - Good | Medium - Good | Medium - Good | Good | Good |
| Cleaning | Good | Medium | Medium | Good | Very good |
| Replacing the | Simply | Relatively costly | Simply | Relatively | Elaborate |
| diaphragm | | | | costly | |

Different membranes should be tested and a suitable membrane system developed for each application. In this way, investment and operating costs can be better estimated and minimized. The necessary steps to elaborate and develop such a membrane system are considered in section 1.4.2.

### 1.2.2.2 Operating Modes

Basically, there are four operating modes with which a membrane system can be operated. Batch operation is one of them. In this operating mode, filtration is continued until the desired concentration in the retentate is reached. Furthermore, filtration can be operated as a single pass or feed and bleed system. The single pass is a continuous operation in which no recirculation of the retentate is provided. The feed and bleed system, on the other hand, allows continuous filtration at a constant filtration rate, despite the high influence of feed concentration on filter performance. The fourth operating mode is the multi-stage operation, also called cascade system. Here, after the first filtration, the retentate or permeate is passed as feed to the next stage or over the next membrane until the desired concentration or product is achieved.

1.2.2.3 Food Law Situation when Using Membranes

When using membranes in food processes, it must be ensured that there is no migration from the membrane into the product and that the membrane does not negatively change the product. Legislation states that materials coming into contact with food must be produced in accordance with good manufacturing practice (GMP). These materials must not release components into the food in quantities that endanger human health, alter the food composition in an unacceptable way, or impair the organoleptic properties of the food. From the point of view of food law, the membrane belongs to the consumer goods category. In Switzerland, the Ordinance of the Federal Department of Home Affairs (FDHA) of Dec. 16, 2016, on materials and articles intended to come into contact with food (Consumer Goods Ordinance, SR 817.023.21) is relevant, which sets out the general requirements for consumer goods in Articles 3-8. For more specific requirements, the material of which the membrane is composed must be known. This is therefore important, as according to Swiss and EU law, so-called declarations of conformity are required for products made of certain materials. According to Regulation (EC) No. 1935/2004 of the European Parliament and of the Council on materials and articles intended to come into contact with food, the relevant product categories are:
1. active and intelligent materials
2. adhesives
3. ceramics
4. cork
5. rubber
6. glass
7. ion exchange resins
8. metals and alloys
9. paper and cardboard
10. plastics
11. printing inks
12. regenerated cellulose
13. silicones
14. textiles
15. paints and coatings
16. wax

The Declaration of Conformity proves that the FCMs (Food Contact Material) used comply with all food law requirements. It is an essential element of self-regulation, which is relevant for all manufacturers, distributors and users of FCMs involved. All parties involved are responsible for food law conformity at their respective level. In addition to taking responsibility for conformity within the supplied specification, this can also be handed over by delegating remaining conformity work, with precise information on the work that remains to be done. A central component of the conformity work is the declaration of conformity already mentioned. This assumes the food law compliance of the FCM when used as specified. However, it is only required for FCMs made of plastic, cellulose, ceramics, and active and intelligent materials explicitly and with specified content. Specific requirements for the content of a declaration of compliance for FCMs made of plastic, for example, are described in the Swiss Commodities Ordinance (SR 817.023.21) or the EU Commission Regulation No. 10/2011 on plastic materials and articles.

### 1.3 Fractionation

In fats, fractional crystallization can remove unwanted components or enrich desired triacylglycerol's (TAG). In the food industry, fractionation is used to produce special fats with standardized properties. For this purpose, the fat is cooled slowly so that the high-melting TAG crystallize as selectively as possible. As far as possible, no solid solutions should be formed. To achieve fractionation in sufficient sharpness, of two or more components, a melting point difference of at least 10° C. is necessary. The melting range of a TAG depends on the position of the fatty acids in the molecule. Due to their individual mixtures of TAG, the various fats have melting ranges typical of their type instead of precise melting points. After cooling or fractionation, the crystals must be separated. This is done either by filtration or by washing with a surfactant solution. Another variation is fractionation after dissolving in hexane or another solvent. Although this allows a sharper separation, it is economically worthwhile only in very special cases due to the higher expense of the process. The melting points of some fatty acids are listed in Table 2.

TABLE 2
Melting points of various fatty acids and glycerol's
Melting point [° C.]

| | | 1-Monoacyl- | 1,3-Diacyl- | Triacylglycerol |
|---|---|---|---|---|
| | Fatty acid | glycerol | glycerol | (TAG) |
| Lauric acid | 40.0 | 63.0 | 56.5 | 46.5 |
| Palmitic acid | 62.9 | 77.0 | 72.5 | 65.5 |
| Stearic acid | 69.6 | 81.0 | 78.0 | 73.0 |
| Oleic acid | 16.3 | 35.2 | 21.5 | 5.5 |
| Elaidic acid | 45.0 | 58.5 | 55.0 | 42.0 |
| Linoleic acid | −5.0 | 12.3 | −2.6 | −13.1 |
| Linolenic acid | −11.0 | 15.7 | −12.3 | −24.2 |

### 1.4 Scale-Up

In the technical realization of processes in which chemical and microbiological mass conversions are associated with mass and heat exchange, experimental plants usually behave differently at laboratory or pilot plant scale than at the final operating scale. Thus, heterogeneous basic operations such as mixing, sieving, filtering or centrifuging are referred to as scale-dependent processes. In order to be able to represent such processes in the model and to obtain information about the design and dimensioning of a new technical plant, a number of important questions must be answered. This may involve not only a scale-up but also a scale-down. However, the term scale-up is not used exclusively for scale enlargement, but also includes scale reduction. In summary, it can therefore be defined as the systematic generation of process knowledge with the aim of transforming ideas into successful implementations.

Knowledge generation involves literature review, consulting consultants and experts, conducting experiments, and design and modelling. Risks can thus be assessed and reduced to an acceptable level. Successful implementation is achieved when the process meets the design objectives at commercial scale.

### 1.4.1 Basics of a Scale-Up

A scale-up is a model transfer, whereby it must be taken into account that physical processes behave differently with changing size ratios of the apparatus. Thus, procedural, dimensionless ratios or physical quantities, which remain constant during a scale-up, must be defined as transfer criteria.

If a new technology, such as membrane technology, is already being used successfully in one industry, implementation of the technology in a new area should be approached with caution. Different fields of work have different operating procedures and reliable operation of the technology may be achieved in a very different way in each field.

If a chemical or physical-technical problem is to be described by a mathematical relation and to be valid in any dimension system, this must be formulated dimension-homogeneously. A dimension is defined in summary as a purely qualitative description of a property or appearance. Thus, each physical concept can be assigned a type of quantity and each type of quantity in turn can be assigned a dimension. The dimension of mass, for example, is defined as mass (M) and that of length as length (L). As a secondary type of quantity, the dimension L² is then used as an example for the area. It can happen that different types of sizes have the same dimension. Unlike the dimension, a physical quantity is defined as a quantitative description of a physical property and is composed of a numerical value and a unit of measurement (e.g. 5 kg). However, since units of measure can differ, a unit of measure must be agreed upon in a system of units of measure. In scale-up, dimensionless ratios are often used. This allows seemingly incompatible experimental results to be compared with each other and their ranges of validity to be significantly increased. All influencing variables can be summarized in a few dimensionless indices, such as the Reynolds or Euler number. Another example of a dimensionless ratio is the hydraulic gradient (i), which is used in fluid mechanics, more precisely expressed in the Darcy equation. The Reynolds number (Re) is used in fluid mechanics and shows the relationship between inertial and viscous forces, or provides information about the turbulence behaviour of flows. For example, two tubular membrane modules of different sizes exhibit the same turbulence behaviour if the Reynolds number is identical. This makes it clear that when scaling up flow-dependent processes, the Reynolds number should be included in the model transfer to avoid flow-dependent changes in the process. The Reynolds number incorporates the density (p), flow velocity (v), characteristic length (d), and dynamic viscosity (n). The corresponding formula is given in section 3.2.6.

With a given transformation rule and the same dimensionless ratios, all quantities of two processes defined by the same mathematical model can be transferred from one to the other.

### 1.4.2 Concept Design in the Context of the Scale-Up of a Membrane System

In order to determine the required data for a scale-up, the concept design is essential as the starting point of any process development. This section looks at the concept design procedure, specifically using the development of a membrane system as an example.

Concept design serves several purposes during a development phase. During the design of the process concept, information gaps for a reliable design become apparent, which should subsequently be closed by research work. Thus, the concept design already supports the definition of necessary research work.

A possible procedure for designing a membrane system is shown schematically in FIG. 4. The first step is to define the goal of the separation. For this purpose, the membrane characteristics (material, membrane type, polarity) as well as the way the membrane will be used (module type, operating mode, system design) have to be considered. The polarity and the pore size of the corresponding membranes can play an important role (see also Table 1). FIG. 4 shows a proposed approach for the design of a membrane system. After the system design step, the system is evaluated and thus the system design is revised again until the system can be implemented in the final application.

Selecting the right membrane and membrane system is essential for successful implementation of a new application, but it is not yet sufficient. In order to understand the properties and performance of the membrane process as well as the system parameters over time, laboratory scale tests as well as tests on a pilot plant have to be performed. In this way, membrane filtration can be characterized and optimized until implementation in the targeted application is possible.

The following section identifies and explains the key points and steps that should be considered during the course of a successful membrane system design.

### 1.4.2.1 Membrane Selection and Determination of System Parameters

This section highlights the membrane selection, system parameter determination, and module testing steps shown in FIG. 4.

A wide range of test units are available for laboratory-scale tests. One of them is Alfa Laval's Test Unit M20, which enables tests with both flat membranes and spiral wound modules. The plates of the unit allow separated permeate outlets, which enables validation of several membranes at the same time. Furthermore, this test facility can provide larger quantities of samples for further processing and analysis. Establishing a mass balance during laboratory testing is recommended to assess unexpected changes in product during membrane filtration. For example, the increase in concentration on the input side can be determined by a simple mass balance.

After successful completion of initial laboratory tests, further tests can be carried out on pilot plants to determine the optimum process conditions. In pilot plants, tube or spiral wound modules with different masses can be tested in parallel or in series. To determine the TMP, pressure sensors are needed before and after the module. In addition to recording the pressure, the temperature must also be monitored. This can influence the viscosity of the medium to be filtered and thus also the filtration. Pilot tests are also conducted to determine the dependence of permeate flux on the concentration in the retentate and batch-to-batch reproducibility. Other important parameters that should be determined during pilot plant trials are:
Determination of filtration properties as a function of process parameters (temperature, pressure, volume flow)
Determination of the filtration properties as a function of the concentration in the circuit
Selection of the configuration of the membrane elements (e.g. spacers).

By running as long as possible, during the pilot plant trials, knowledge can be gained about fouling and filter performance over time.

### 1.4.2.2 System Design of a Membrane-Based Filtration Plant

Based on the data from the laboratory and pilot tests, a membrane system can be developed on the desired scale in the design phase. For this purpose, the following parameters should have been determined or calculated.
Mass balance: The permeate and retentate flow rates, together with the membrane retention factor, allow the calculation of the relevant substances (e.g. TPA) in the permeate and retentate streams.
Process parameters: Pressure, temperature, permeate volume flow and retention factor (as a function of pressure, temperature and concentration in the retentate).
System design: functionality, total number of elements, enclosures and frames, arrangement of elements in enclosures, and configuration and staging.

Other parameters such as mode of operation, membrane surface area required, design and configuration of membrane spacers, and the number of elements required in the housing must also be determined as the basis of the design phase.

A membrane system can be designed with a single or multiple operating stages. If the feed concentration has little influence on the filtration performance, a single pass is usually sufficient. Multiple operating stages are more complex and costly, but allow efficient filtration when the influence of feed concentration on filtration performance is large. If the aim of filtration is to concentrate the retentate and the influence of feed concentration is minor, batch systems are usually used.

To control a membrane system, three types can generally be considered:
Constant concentration factor
Constant pressure
Constant permeate flow

The selection of the appropriate type of control depends on the characteristics of the feed, the influence of the concentrations and the system pressure in case of contamination. When using the constant concentration factor, the ratio between concentration in the permeate and concentration in the retentate is kept constant. The concentrate flow rate is continuously adjusted by a control valve, which receives the measured value from the permeate flow meter. As soon as the membrane is fouled, the system pressure increases to maintain a constant permeate and retentate flow. The system is stopped, cleaned and restarted when a certain pressure is reached.

The most common way to control the system is constant pressure. The measurements and control instruments are simple and inexpensive. Increasingly, processes are designed below the critical maximum pressure of the membrane, resulting in reduced fouling, longer intervals between cleanings, and longer membrane life. A third option for membrane system control, typically used in industrial biotechnology applications, is constant permeate flow. In this process, permeate is removed at a constant rate by a control valve or pump. The system pressure increases over time to compensate for the decrease in permeate flux due to concentration polarization and fouling. In this mode, both the concentration factor and the system pressure are increased over time. For continuous systems, this may mean that chemical cleaning is not required for an extended period of time.

One of the key factors of any membrane system is the membrane area. The required membrane area, can be calculated depending on the desired separation. The life of a membrane can be up to six years, depending on the application and material. For applications with oil, the service life is between six months and three years and can be determined by load tests and the manufacturer's empirical values. It is imperative that these values be included in the costing and economic evaluation of the system. In addition to the service life, the following factors must be taken into account when estimating the costs of a membrane system:
Initial investment costs
Operating costs
Membrane replacement costs
Cleaning costs (including cleaning agents and effort)
Maintenance costs
Depreciation

### 1.4.2.3 Risk Analysis

When designing a system for a new process, a risk analysis is recommended. Since not all relevant information is available, this often proves difficult. For example, if a specific piece of information is missing, it can be defined as “unknown”. However, it often happens that the knowledge of the unknown is also not available. Thus, a distinction is made between specific knowledge gaps and unknown knowledge gaps. For this reason, risk analyses should be performed at various points in an innovation process. After each risk analysis, knowledge gaps can be closed and new risk factors can be identified. In this way, the risk assessment is continuously improved and countermeasures can be initiated if the risk is too high. Risks can be divided into the following risk dimensions:
Security
Health
Environment
Social
Economy
Technology

Related to the technical risk dimension in the research and development phase, these risk factors can be useful:
Number of new process steps
Lack of knowledge about the composition of the product stream
Occurrence of streams containing solids

The number of new process steps refers to process steps that have never been used on a commercial scale in this specific application. This also includes process steps that are already established in other areas. Another risk factor is the knowledge of the product stream and its composition. This is important for successful scale-up, as possible interactions of the surfaces with the product can lead to contamination, and incorrect material selection can lead to rapid corrosion, fouling as well as foaming. Solids in the product stream were defined as the third risk factor. Streams containing solids have a tendency to stick together, settle in dead corners, and flow irregularly. However, this factor also includes solids such as polymerization products that are formed in the process. In addition to the three main risk factors mentioned above, rotating or moving parts such as pumps, valves, compressors or conveying equipment are usually responsible for equipment failure.

### 1.5 Analytics

Traditional evaluation of frying oils has been based on changes in color, odor, viscosity (foaming) and smoke point. In order to perform a more objective characterization, analytical methods have been developed to quantify various degradation products. In most countries, the method for determining TPA is recognized as an evaluation criterion and its limits are set by law. These are 27% in Switzerland and 24% in the EU. TPA covers all compounds that are more polar than the original triglycerides and are formed during fat degradation. The degradation products recorded are mainly oxidized and oligomerized triglycerides, free fatty acids (FFS), mono- and diglycerides, oxidized and oligomerized sterols and degradation products of antioxidants and other components of the oil and food. However, TPA alone cannot provide a definitive statement about the quality of the frying oil. Therefore, the German Society for Fat Science recommends analyzing other parameters or spoilage indicators such as polymeric triglycerides (PTG), peroxide value (PZ), anisidine value (AnZ), acid value (SZ) and the free fatty acids (FFS).

To estimate the sensory spoilage of frying oil and to avoid having to determine the frying oil quality with a single parameter, the DEGLEV (level of degradation) value can be used. This was developed through a linear regression equation (y=117−8×SZ−3×TPA). It is intended to analytically determine the point at which a frying oil is sensory spoiled and must be discarded. This method is independent of the oil composition, the frying material and the frying conditions. As a general rule, the frying oil should be disposed of when the DEGLEV value is below 50.

There are several methods to measure spoilage indicators. Analyses that require high accuracy should be performed using a standard DGF or American Oil Chemists Society (AOCS) method. This includes the Fourier Transform near infrared spectroscopy (FT-NIR) method.

### 1.5.1 Fourier Transform Near Infrared Spectroscopy (FT-NIR)

The FT-NIR method can be used to perform qualitative and quantitative non-destructive analyses in the food and beverage industry. It enables time-saving measurements of various parameters in a single analysis run without chemicals or solvents. NIR spectroscopy is one of the molecular spectroscopy methods that uses the interaction of matter with light in the near-infrared region of the electromagnetic spectrum to provide qualitative and quantitative information about the sample. Excitation of molecules by radiation leads to molecular vibrations that can be detected in the near-infrared region (780-2500 nm). The vibrating molecules are mainly hydroxy, amino, methine and carbonyl groups. The basis for the use of the NIR method is Lambert-Beer's law. This states that the absorption at a wavelength is proportional to the concentration of the respective substance. The many NIR spectrometers available on the market differ, for example, in the way they generate light. They can basically be divided into the groups of diodes, filter, prism, grating, AOTF and Fourier transform spectrometers. Depending on the application, not only the spectrometer but also the type of sample presentation can differ. For solids, the principle of reflection is usually used, whereas for liquids, depending on the property, transmission or transfection is used.

The basis for a usable NIR analysis is calibration models. A variety of regression methods and data transformations are available to translate the measured spectral data into chemical information. These are summarized under the term “chemometrics”. By using standardized, chemical methods, reference measurements are made that can be transformed into a calibration model. For each parameter that is to be measured, a calibration is required. This in turn also means that the accuracy of the NIR methods can only ever be as accurate as the reference analysis used for the calibration model. For each measurement a residual can be specified. Since the residual basically indicates the deviation between the reconstructed spectrum and the original spectrum, it is also called spectrum reconstruction value. At the beginning, the spectra are subjected to a principal component analysis (PCA). This converts the spectra to points in a multidimensional system. This calculation can also be reversed and the points can be converted back to spectra. The resulting spectra are called reconstructed spectra. This residual only indicates how much the measured sample differs from the sample from the calibration samples and does not give any information about the measurement accuracy.

### 1.5.2 Color Measurement

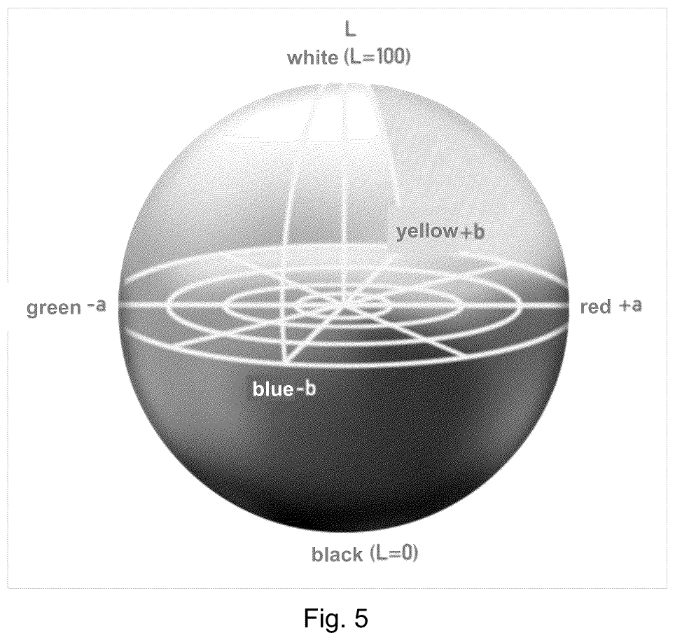

The human perception of color is often very subjective. This leads to problems in defining and communicating product colors and makes a uniform evaluation impossible. The perception of color depends on the type of light source, object size, viewing and object background. To objectively evaluate color, it can be divided into the three attributes: Hue, Lightness and Saturation. These can be determined with different systems. The most widely used system is the L*a*b system, also called the CIELAB system. The color space is described by the brightness L* and the coordinates a* and b*. In FIG. 5 such a three-dimensional color body is shown. The L*a*b* color space also makes it possible to specify small color differences with a single value (E*ab). However, this only indicates the amount of the color difference and not the direction in the L*a*b* system. FIG. 5 shows a model of the CIELAB color space that contains all perceptible colors and is independent of specific media or devices.

### 1.5.3 Sensory Tester Methods

The sensory evaluation of foods according to appearance, odor, taste and texture cannot be neglected for the evaluation of a new process in addition to the analytical methods. The sensory properties of fried foods are highly dependent on the oil used. For this reason, a sensory evaluation of the final products is recommended for the quality determination of the frying oil. In the following section, relevant sensory methods for quality control of products of a new process are shown.

### 1.5.3.1 Selection of Quality Control Methods

In quality control, sensory tests are subject to special requirements. For example, the tests should be quick and easy to perform, the test results should lead to quality assessments and decisions without complicated selection procedures, and the assessment criteria should be based on sensory specifications so that the results are objectively comprehensible. These requirements are best met by the In-Out Test.

Profile testing is a sensory method which allows very detailed and objectified assessments. The evaluation and quality assessment are decoupled in this method. The trained testers determine the intensities of attributes according to the procedure of a profile test.

The classic difference tests (duo, duo-trio, triangle tests) are less suitable for quality control, as they are designed more for the detection of small differences.

### 1.5.3.2 In-Out Test

The in-out test, as a standard sensory method for quality control, has become increasingly established in manufacturing companies. The desired sensory quality and the permissible deviations must be specified in advance for an in-out evaluation by means of attributes and intensities.

A distinction can be made between the following three variants, which differ in their increasing complexity:
Categorical in-out test with simple in-out assessment
Scaled in-out test with graded in-out assessment
Descriptive in-out test with graded in-out assessment and short profile.

For stock tests as well as for the start-up phase of a new product or a new line, quality deviations are usually expected. In these cases, the descriptive In-Out test is a good choice. Here, a simplified profile test is attached to the In-Out decision, thus generating quantitative information that can be evaluated statistically. For this in-out test, the testers must be trained to fully understand attributes and to be able to evaluate them with the intensities. The profile test is described in the DIN 10967-2 standard.

### 2 Material

### 2.1 Materials in General Use

Table 3 lists materials that are required or commonly used for a wide variety of applications and experiments.

TABLE 3
Materials generally used during the experiments

| Materials | Specific data |
|---|---|
| French fries | Pistor: Art. 5586 TK Golden Frites normal cut |
| | Carton of 10 kg from Frigemo |
| Chicken nuggets | 30757TK Chicken nuggets raw BIANCHI CH |
| | Thigh meat shaped breaded 4 × 2.5 kg |
| Sample container | CELLSTAR ® TUBES 15 ml |
| | Wide neck bottles 50 ml, HuberLab |
| Pasteur pipettes | Transfer pipettes BIOSIGMA rod volume 3 ml |
| Detergent | Hellmanex ® III from Hellma |
| Laboratory material | Beakers, graduated cylinders, Erlenmeyer flasks, |
| Container | 15 liter canister for oil |
| Scale | Mettler Type PM 6000 Serial No.: J55737 |
| Kitchen material | Bowls, ladle, measuring cup, spoon |
| Tool | Various standard tools |

### 2.2 Oils Used

Unless otherwise described, HOLL rapeseed oil is used for the tests. The SV Group provides used HOLL rapeseed oil from the canteens and also supplies the fresh frying oil from Pistor (Art. No. 2643). Table 4 shows the oil designations used in the work and their detailed description.

| Oil designation | Specific data |
|---|---|
| Fresh | HOLL Rapeseed oil, Bibox, Suisse Garantie, Pistor |
| | (Art. No. 2643) |
| Used | HOLL rapeseed oil, used in Mensa Vista (TPA: 17%) |
| Rancidity | Virgin Olive Oil: Rancid Median: 8.65 from |
| standard | International Olive Council in 28002 Madrid |

### 3 Method

The experiments are set up following the procedure described in paragraph 2.4.2 for the creation of a membrane system. The first step of the objective setting as well as a first membrane selection have already been performed in an earlier phase of the OLFO project. The steps and experiments described here serve for a more accurate membrane selection as well as for the determination of the system parameters. Further, work on the development of the system design is carried out in paragraphs 4.5 as well as 4.6. An initial evaluation of the developed system design and the process design, respectively, will be performed in paragraphs 4.7 and 4.8. Implementation will take place later in the project and is not covered in this thesis.

### 3.1 Equipment

The following paragraph lists the equipment and installations used and describes any modifications made. The analyzers are not considered in this paragraph and are described separately in section 3.2.

### 3.1.1 Membrane Filtration Plant

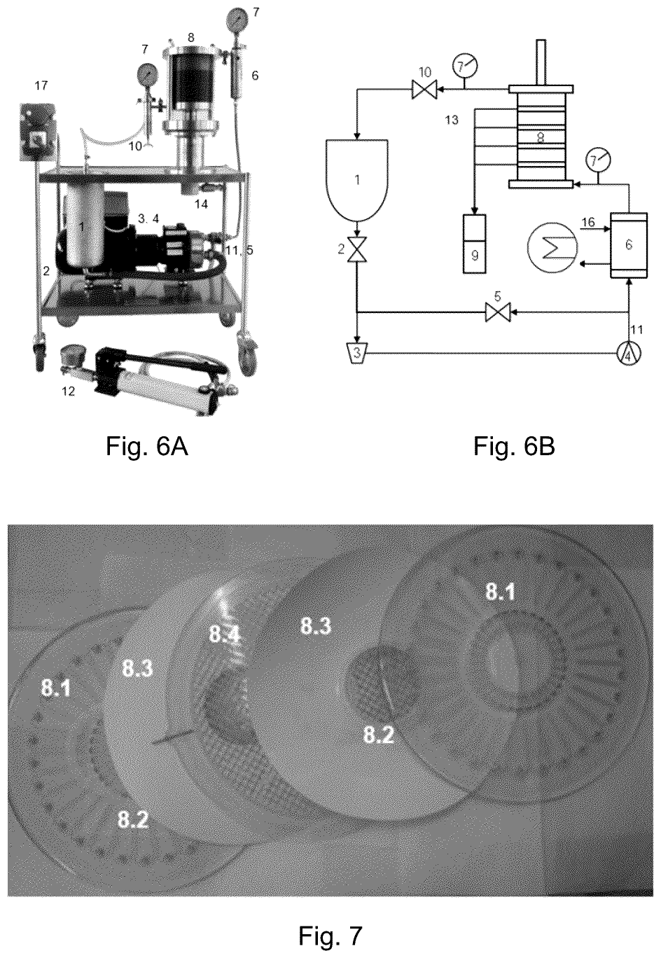

TheTestUnit M20 from Alfa Laval shown in FIGS. 6A and 6B is used for membrane filtration. This makes it possible to test a wide variety of membranes in one plate module. The test unit consists of tank 1, valve 2, control pump 4, safety diaphragm 3 of the control pump, check valve of the control pump, heat exchange jacket 6, pressure gauge 7, plate module 8, collection tank 9 for the permeate (not shown), pressure gauge valve 10, screw 11 for venting the piston pump, hydraulic pump 12, permeate lines 13 at the plate module, pressure valve 14, heat exchanger 15, connecting hoses 16 between heat exchanger and heat jacket and manual control 17 for starting/stopping the system and for setting the number of revolutions of the piston pump.

Up to 20 membranes can be clamped simultaneously in this test system. The structure of the individual plate module components is shown in FIG. 7. The required threaded rings are of the type DSS Neck Ring M20 and are distributed by Alfa Laval. The plate module components consist of spacer plate 8.1, threaded ring 8.2, diaphragm 8.3 and support plate 8.4.

### 3.1.1.1 Adjustments

In order to meet the various requirements during the tests and to be able to maintain uniform process conditions, various adjustments are made to the test plant. In order to achieve oil temperatures of up to 90° C. and to be able to keep them constant, a specially made immersion heater from Backer (230V/7000W) with a temperature controller (Tecon Control from Roth+Co. AG, serial number: 5-492) is installed in the feed tank. Since the standard test equipment does not include a lid for the feed tank, a silicone lid is cut to fit the cover. The feed tank is also insulated with 5 mm of self-adhesive thermal insulation. For the use of ceramic membranes, an additional filtration housing (M1-10x500-PN25-TC-SO from Inopor) is used. This is equipped with Tri-Clamp ½″ connections (DIN32676 series C) and can be connected to the TestUnit M20 instead of the plate module (number 8 in FIGS. 6A and 6B).

### 3.1.1.2 Membranes Used

The following membranes are tested on the TestUnit M20: PERVAP 4060, GMT oNF-1 and GMT oNF-3. In addition, a ceramic membrane (TiO2 5 nm, hydrophobic) from the company Inopor, is used for the test described in section 3.4.1.

### 3.1.2 Contherm

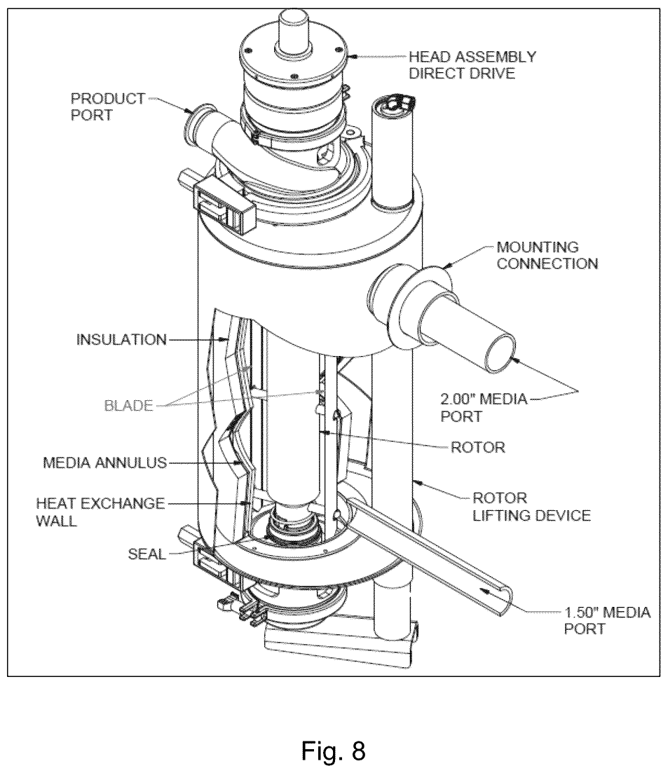

The Contherm scraped surface heat exchanger from Alfa Laval is used for fractionation. A schematic of the heat exchanger with a filling volume of 7.6 liters and four scrapers is shown in FIG. 8.

For the combined method experiment in Section 3.4.1, the following additional materials and equipment are used:
Peristaltic squeeze pump (Watson Marlow from SKAN AG Basel)
Hose (GARDENA Profi Plus, rubber)
Chiller (Huber Unistat 430, serial no.: 263312/16)

### 3.1.3 Almemo Temperature Measuring System

An Almemo measuring system with the corresponding sensors is used for the temperature and humidity measurements. Table 5 lists the elements used in detail. Further information can be found in the Ahlborn manufacturer's catalog.

TABLE 5
Detailed information on the elements of the
ALMEMO ® measuring system

| Device | Specific data |
|---|---|
| Data | Modules for data transmission ALMEMO 8590-9 |
| transmission | Serial No. T12100294, AHLBORN |
| modules | |
| Laptop | Dell Latitude E 6430 with Windows 10 Enterprise |
| | with ALMEMO AMR WIN CONTROL Software and |
| | Microsoft Excel |
| Bluetooth | Bluetooth receiver, radio module ZA 1719-BTX1XS, |
| transmitter/ | ALMEMO, AHLBORN |
| receiver | Bluetooth transmitter, radio module ZA 1719-BTX1XS, |
| | ALMEMO, AHLBORN |
| Temperature | NiCr—Ni type K (ZA 9020-FS) |
| sensors and | Pt100 cable probe |
| Plug | NiCr—Ni thermal wire T 190-0 |
| | NiCr—Ni type K (R2E4) |
| | NiCr—Ni sensor FTA 025 P |
| | NiCr—Ni type K (ZA 9020-FS), |
| Digital probe | For humidity, temperature, air pressure FHAD 46-C0, |
| | exposed sensor element, with ALMEMO ® D6 connector. |

### 3.1.4 Prototype Deep Fryer

The materials used for the prototype are listed in Table 6.

TABLE 6
Materials used for connecting the fryer to the TestUnit M20

| Device | Specific data |
|---|---|
| Deep fryer | F2-400 from Gastrofrit (modified and flexibly |
| | mounted on an open rack) |
| Pump | G300XK/DC24 Gear pump from Nanjing Ouruike Pump |
| | & Valve Co., Ltd., regulated with voltage regulator |
| Voltage | HQ Power, Model: PS1503SB, Input: 230 V AC 50 Hz, |
| regulator | Output: 0-15 V DC; 0-3 AMP |
| Level sensor | Ultrasonic sensor UPS 200 TVPA 24 C, measuring range |
| | 200 mm, switching output PNP, teach-in, design M12, |
| | connector outlet M12, 4-pin Product: SNT Sensortechnik |
| | AG |
| CPU control | Mitsubishi Alpha Power, AL-10MR-D, 24-1.5, AC 100- |
| | 240 V; DC24 V 1.5 A with Alpha Software |
| Hose | PTFE hose Ø10 mm from Maagtechnic (Art. No. |
| | 10075784) |
| | Silicone pressure hose Unisil W Material: VMQ, smooth, |
| | from Angst & Pfister (Art. No. 06.5331.7010) |
| Hose | Micro hose connector made of PP Y-shape, for hoses |
| connector | with inner diam. = 1.5 mm from Huberlab |
| | (3.3210.66) |
| Solenoid | Tri-Matic, Model: NTE-20S, Size: DN15-KT2, 230 V |
| valve | AC, 90 ± 10 mA Serial number: CH548251 |
| Depth filter | 3 mm cellulose filter pad from Filtrox |
| Miscellaneous | Stainless steel connectors, hose clamps, cable |
| | ties, adhesive tape |

The prototype is based on an F2-400 fryer from Gastrofrit. This is mounted in an open rack, extended with the necessary connections and provided by Gastrofrit of the Zurich University of Applied Sciences (ZHAW) for further adaptations.

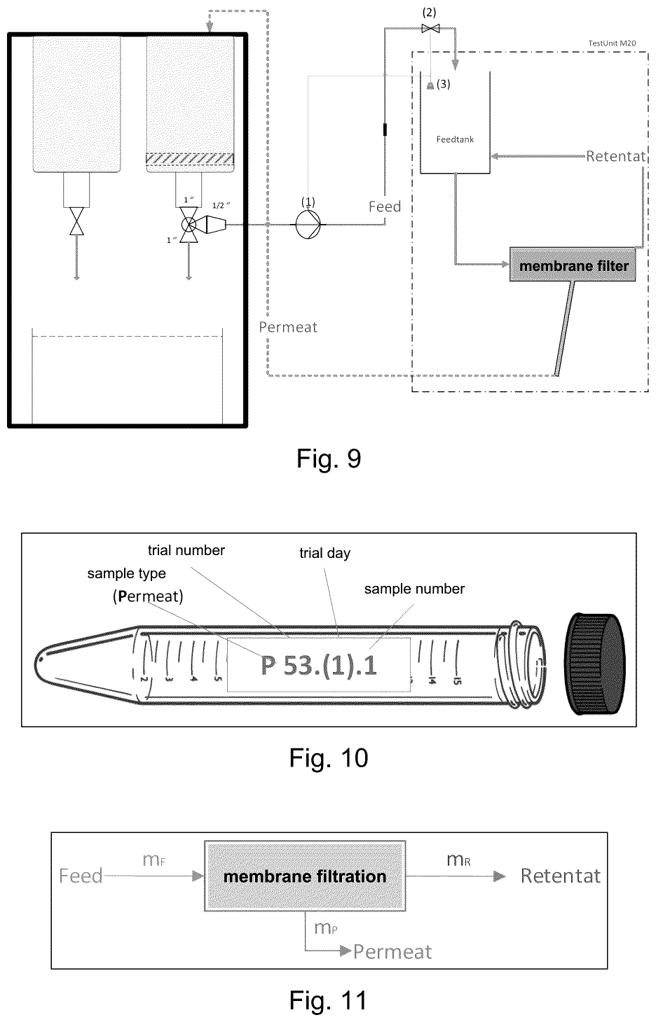

The F2-400 consists of two frying basins. One basin is used as a standard fryer and is not modified. The second basin is used as a prototype fryer and is connected to the adapted M20 membrane test system (see section 3.1.1) as shown in FIG. 9. In the prototype fryer basin, there is a stainless-steel holder into which a filter pad is inserted. The connections between the fryer and the TestUnit M20 are made using the polytetrafluoroethylene (PTFE) tubing listed in Table 6.

The pump (1) and the solenoid valve (2) are controlled by a level sensor (3) and a central processing unit (CPU control). If the level falls below a defined level for at least five seconds, a 24V signal is sent from the level sensor (3) to the Alpha control. The signal drops out again as soon as the likewise defined maximum level in the tank is reached. The control is programmed so that the solenoid valve (2) opens when the signal is active and the pump (1) is activated. The programming provides for a delay of 20 seconds after loss of the signal before the pump is deactivated again and the valve is closed. Thus, the level after filling is slightly above the set maximum level.

### 3.2 Analytics

Various analytical methods are required to quantify the spoilage characteristics and evaluate the frying oil. This section discusses all the analytical methods used and describes the analytical equipment used for them.

### 3.2.1 Specimen Pulling and Labelling

The frying oil samples are filled into tubes of 15 ml or wide-neck bottles of 50 ml, depending on the quantity required, and labelled with the test number. The samples are stored protected from light and at 5° C. until further use. The labelling of the sample containers contains the following information, as shown in FIG. 10 as an example: Sample type (permeate (P), retentate (R), feed or frit (F) or standard (S)), test number and sample number. In certain tests, which run over several days, the test day is also noted.

### 3.2.2 FT-NIR

An FT-NIR instrument from Büchi AG, Switzerland is used to determine the spoilage parameters. The method and calibration used is from Torsten Welles, from the Chemical and Veterinary Investigation Office Stuttgart.

Table 7 lists all materials required for the NIR measurements.

TABLE 7
Materials used to measure spoilage indicators with FT-NIR

| Materials | Specific data |
|---|---|
| NIR device | NIRFlex Liquids N-500 SN: 1000272626; from: |
| | Büchi Labortechnik AG |
| Laptop | Dell Latitude E 6430 with Windows 10 Enterprise |
| Büchi Software | NIR Software Suite NIRWare 1.4 |
| Cuvettes | Hellma Analytics High Precision Light Path 2 mm |
| | Cell SN: 100-2-20 |
| Ethanol | 70% in spray bottle |
| Other | Disposable wipes, tube stand |

An application will also be created for the project to customize the analysis settings to meet the needs of the project. Information on how to create an application can be found in the NIR training materials. The FT-NIR analyses will be performed as described in the standard operating procedure (SOP) for the analyzer. In each case, a triple determination is performed and the mean and standard deviation of the measurements are determined.

### 3.2.3 Viscometer

The viscosity is measured with the viscometer VT 550 from HAAKE (type: 002-7026). The measuring cup NV ST (807-0702) is filled with 9 ml sample each and the rotating body NV ST (807-0713) is inserted. The temperature is controlled at 70° C. with the Julaba F12 refrigeration circulating pump and the frying oil sample is tempered in the viscometer for five minutes before measurement. For each sample, six measurements are made within 60 seconds at a shear rate of y=200 [1/s] seconds. The mean and standard deviation are determined. The Rheo Win Job Manager software (version: 4.63.0004) is used for the measurements. The dynamic viscosity is given in millipascals (mPas).

### 3.2.4 Color Measurement

The transmission color measurements and color difference measurements are measured with a spectrophotometer and the color is determined by transmission using the L*a*b color space. The materials listed in Table 8 are used for this purpose.

TABLE 8
Materials used for reflectance color measurement
and color difference measurements.

| Materials | Specific data |
|---|---|
| Spectrophotometer | Spectrophotometer CM-5 from Konica Minolta |
| Specimen holder | CM-A96 Transmission from Konica Minolta |
| Cuvettes | CM-A98 Glass rectangular cell 50 × 38 Layer |
| | thickness 10 mm |
| Other | Disposable wipes, disposable pipettes |

The “Transmission” function is selected in the instrument and the measurements are performed in triplicate and in transmission using the SOP of the instrument. To determine the color differences of the samples, the ΔE*ab value is determined. In addition, the browning index (BI) is calculated. The following formulas are used for this purpose:

$$\\ \begin{matrix}Color difference Δ {E}^{{}_{} *} ab & \\ Δ {E}^{{}_{} *} ab = {[ {( Δ {L}^{{}_{} *} )}^{2} + {( Δ {a}^{{}_{} *} )}^{2} + ( {( Δ {b}^{{}_{} *} )}^{2} ]}^{1 / 2} & ( 1 )\end{matrix}$$

$$\\ \begin{matrix}Tanning Index ( BI ) & \\ BI = [ 100 ( x - 0.31 ) ] / 0.17 where : & ( 2 )\end{matrix}$$

$$\\ x = ( {a}^{{}_{} *} + 1.75 {L}^{{}_{} *} ) / ( 5.645 {L}^{{}_{} *} + {a}^{{}_{} *} - 0.3012 {b}^{{}_{} *} )$$

### 3.2.5 Measurement of Permeate Flux

The permeate flux is determined with a measuring cylinder and as a single determination. The measurement period varies depending on the test setup and can be seen in the respective test protocols.

### 3.2.6 Calculation of Further Key Figures

With the data obtained from the various filtration tests and the FT-NIR analyses, further key figures are calculated in each case. The formulas used for the respective key figures are listed below. For the comparison of the data series from the frying test, the Kruskal-Wallis test is applied. For this and for all statistical key figures and calculations, the statistical program XLSTAT version 10 2018.5 is used.

$$\\ \begin{matrix}Reynolds number & \\ Re = \frac{ρ \cdot υ \cdot d}{η} where applies : & ( 3 )\end{matrix}$$

$$\\ ρ = density$$

$$\\ υ = velocity of overtopping$$

$$\\ d = characteristical length$$

$$\\ η = dynamic viscosity$$

$$\\ \begin{matrix}Retention factor & \\ R = \frac{{C}_{R} - {C}_{p}}{{C}_{R}} where applies : & ( 4 )\end{matrix}$$

$$\\ R = restraining factor$$

$$\\ {C}_{R} = TPA concentration in retentate$$

$$\\ \begin{matrix}DEGLEV & \\ y = 117 - 8 \times SZ - 3 \times TPA where applies : & ( 5 )\end{matrix}$$

$$\\ SZ = acid number$$

$$\\ TPA = total polar fraction in \%$$

### 3.2.7 Sensory Testing

A descriptive in-out test is used for the sensory evaluation. The DIN 10975 and DIN 10973 standards serve as the basis for this method. Thus, on the one hand the French fries and on the other hand also the frying oil are assessed.

### Test Persons

The panel of testers is made up of staff from the Institute for Food and Beverage Innovation (ILGI) at ZHAW. Six examiners are trained with the aim of having at least three examiners available for each test.

### Preparatory Training

The basic principle of the In-Out test is explained to the examiners and the objective of the sensory tests to be performed is explained.

A sample deep-fried in fresh frying oil is served as the standard sample. Subsequently, the testers are presented with French fries prepared monadically in different oils. The frying time is four minutes at 170° C. Table 9 shows the samples handed out with the respective oils used (See also section 2.2).

TABLE 9
Oil mixtures for the samples used in the sensory training.

| Sample | | | Evaluation |
|---|---|---|---|
| designation | Frying oil | Oil additive | (IN-OUT) |
| Oil 1 | Fresh (600 ml) | None | in |
| Oil 2 | Fresh (400 ml) + used | 13 ml | just out |
| | (100 ml) | Rancidity standard | |
| Oil 3 | Used (600 ml, TPA | None | in |
| | 17%) | | |
| Oil 4 | Used + 50 ml retentate | None | out |
| | from trial GMT 53 | | |
| Oil 5 | HOLL Rapeseed oil | 20 ml | just out |
| | fresh | Rancidity standard | |

### Execution During the Frying Test

The test persons are each given two samples of French fries and two samples of frying oil, which are each labelled A and B. The samples are taken from the standard fryer and from the prototype fryer. Sample A comes from the standard fryer and sample B from the prototype fryer. These are evaluated by the testers using the prepared test form.

### Evaluation

In-Out results are reported as a percentage of “in” or “just in” decisions. If a product is not rated with 100% “in” responses, then the reviewer count for the next review session will be increased. If a product is rated “out” with at least 33%, then the project team will decide whether to continue the frying trial. The results of the profiling are summarized as mean value and with indication of the standard deviation. Due to the small number of testers, no further statistical evaluations are carried out.

### 3.3 Process Analysis

### 3.3.1 Temperature and Humidity Measurements in a Standard Deep Fryer

In order to assess the thermal conditions prevailing inside a running deep fryer, temperature and humidity measurements are carried out on a Gastrofrit F-300 deep fryer at the SV Restaurant “Grüental”.

For this purpose, the materials from section 4.1.3 are used and three measuring probes are fixed in the interior of the deep fryer. A temperature sensor is also mounted directly in the frying basin to monitor the oil temperature.

Sensors are placed at the following measuring points:
Surface temperature side wall inside
Frying pan or oil
Indoor center (air temperature and humidity)
Surface temperature drain cock

### 3.3.2 Mass Balance During Membrane Filtration

It is to be investigated whether the feed-side concentration can be calculated with a simple mass balance, or whether the measured parameters agree with the values calculated by the mass balance. This involves the mass flows shown in FIG. 11. It is to be checked whether the mass of TPA in the feed is equal to the sum of the mass of TPA in the retentate and in the permeate. The following formulas are used:

$$\\ \begin{matrix}Mass balance : {m}_{F} = {m}_{R} + {m}_{P} & ( 6 )\end{matrix}$$

$$\\ \begin{matrix}TPA Balance : {m}_{F} \cdot {TPA}_{F} = {m}_{R} \cdot {TPA}_{R} + {m}_{P} \cdot {TPA}_{P} & ( 7 )\end{matrix}$$

$$\\ \begin{matrix}TPA loss / TPA increase : x = {m}_{F} \cdot {TPA}_{F} - {m}_{R} \cdot {TPA}_{R} - {m}_{P} \cdot {TPA}_{P} & ( 8 )\end{matrix}$$

$$\\ where applies : {m}_{F} = mass feed [ g ]$$

$$\\ {m}_{P} = mass permeate [ g ] .$$

$$\\ {m}_{R} = mass retentate [ g ] .$$

$$\\ {TPA}_{F} = TPA content in feed [ g / g ] .$$

$$\\ {TPA}_{R} = TPA content in retentate [ g / g ] .$$

$$\\ {TPA}_{P} = TPA content in feed [ g / g ] .$$

$$\\ x = Unknown decrease or increase in TPA value [ g ] .$$

To verify this relationship, a filtration test is carried out with the GMT oNF-3 membrane. The test is carried out at 70° C., 20 bar and an overflow of 6 liter/min with the TestUnit M20. A feed quantity of about 3.5 kg of frying oil is used and filtration is terminated after generation of at least 0.7 kg of permeate (20% of the feed quantity). Samples are taken from the feed (before filtration), permeate and retentate (after filtration) and analyzed by FT-NIR. The permeate samples are taken every three hours to detect possible changes during the filtration. The average of all TPAP measurements is used for the mass balance. In addition, the mass of the permeate is determined gravimetrically. Since it is not possible to measure exactly the total volume that remains in the filtration circuit, the mass of the retentate is determined by calculation (m_{F}-m_{P}).

### 3.4 Membrane Filtration

This section describes all experiments that involve membrane filtration. The experiment described in section 3.4.1 deals with the combination of fractionation and membrane filtration. Subsequently, the experiments on classical membrane selection and membrane characterization are presented.

For each of the experiments described, the TestUnit M20 experimental unit is used as a basis (see section 3.1.1). For all membrane tests, samples are taken as standard (see section 3.2.1), the permeate flux is determined with the aid of a measuring cylinder and the running time is noted. The permeate flux and the spoilage parameters of retentate and permeate are evaluated in each case, whereby the focus of the spoilage parameters is on the TPA.

3.4.1 Membrane Filtration after Previous Fractionation

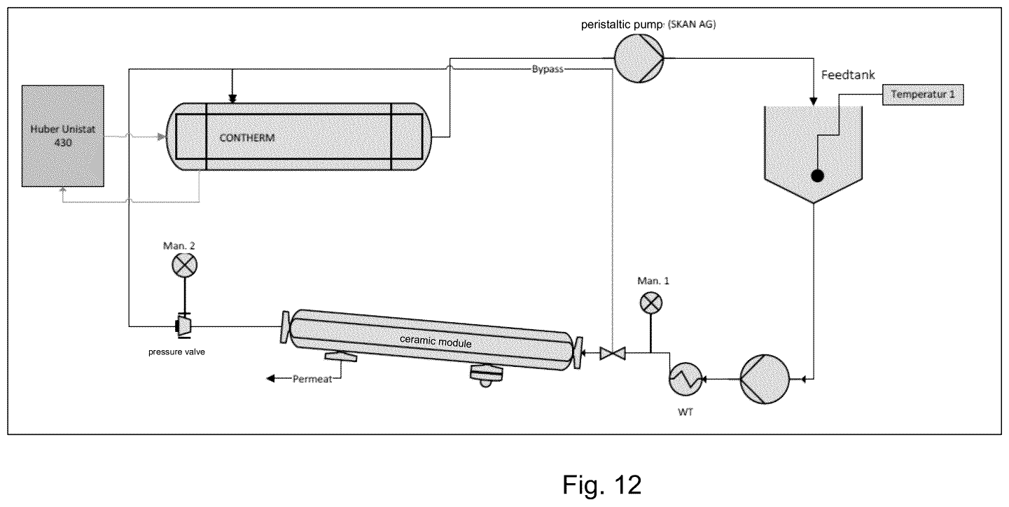

This section describes the trial of a combined process of membrane filtration and fractionation, for which the M20 filtration unit is connected to the Contherm. This trial is intended to demonstrate the feasibility of separating fat crystals from the fractionation from the liquid phase using a membrane separation process. The findings of the preliminary tests serve as a basis for this. The setup of the experiment is shown schematically in FIG. 12. The connection between the Contherm, which is responsible for fractionation, and the filtration system is established by a peristaltic pump. This is set so that the flow is equal to the retentate flow. The frying oil is cooled down to −4° C. in the Contherm over a period of four hours before the circuit is started via the filtration. For filtration, the tubular module for Inopor ceramic membranes is installed. The 5 nm TiO₂ membranes are tested in the hydrophilic and hydrophobic configuration. The permeate flux is measured over two hours in each case.

### 3.4.2 Membrane Selection

The membrane type PERVAP 4060 from the manufacturer DeltaMem AG is a suitable starting membrane. Two other membranes from the company GMT Membrantechnik GmbH were also tested with frying oil (oNF1 and oNF3). Preliminary tests are being carried out for an initial evaluation of the two new membranes from GMT.

During the preliminary tests, process parameters such as pressure or oil temperature are defined by the test manager, and during the tests it is decided whether and which further parameters are to be tested. A systematic characterization of the membrane only takes place if the first test runs show positive results, i.e. if the results show improvements compared to PERVAP 4060 (permeate flux or retention factor). Thus, based on the measurements of Ramona Rüegg, the reference value of the retention factor is set to 0.47 and that of the permeate flux to 0.7 l/h·m². If the results of the newly tested membranes are above these reference values, further tests will be carried out.

Two membrane sheets of 0.0295 m² each are cut for the TestUnit M20 and tested at the process parameters shown in Table 10. According to the data sheet of the manufacturer of the GMT membranes, the membranes should be exposed to the solution to be filtered for two hours before filtration is started. For this reason, the membranes are exposed to the fresh frying oil for two hours before the first test at 3.2 l/min and without pressure in the test plant.

TABLE 10
Process parameters of the preliminary tests
with the GMT o-NF1 and o-NF3 membranes

| | Print | Oil temperature | Overflow | Running |
|---|---|---|---|---|
| Trial number | [bar] | [° C.] | [l/min] | time [h] |
| oNF1-50.1 | 25 | 75 | 6 | 6.0 |
| oNF1-50.2 | 25 | 75 | 6 | 14.3 |
| oNF1-50.3 | 25 | 85 | 12 | 4.0 |
| oNF1-50.4 | 12.5 | 85 | 12 | 19.5 |
| oNF1-50.5 | 30 | 85 | 12 | 3.0 |
| oNF1-50.6 | 30 | 85 | 6 | 3.5 |
| oNF1-50.7 | 35 | 85 | 12 | 3.0 |
| oNF3-53.1 | 25 | 75 | 6 | 2.0 |

### 3.4.3 Membrane Characterization

Membrane characterization is used to generate knowledge to evaluate the properties of individual membranes and define the optimal process conditions for the specific application.

### 3.4.3.1 Characterization PERVAP 4060

Important tests for the characterization of PERVAP 4060 were carried out. In order to investigate the influence of a concentration of the retentate on the permeate flux and the composition of the permeate, an additional long-term test is carried out. For this purpose, filtration is carried out over 190 h and the level in the feed tank is kept at a constant level with regular addition of feed oil (TPA approx. 27%). Since the filtration time plays only a minor role in this experiment, samples are taken at irregular intervals for organizational reasons. Permeate flux will be determined and permeate and retentate samples will be analyzed by FT-NIR. To investigate whether permeate flux decreases with increasing TPA concentration in retentate (TPAR) and how TPA in permeate (TPAp) depends on TPAR. To evaluate whether the decreasing permeate flux is due to fouling or to the changes in the retentate, the experimental condition at the end of the experiment is set back to the parameters prevailing at the beginning. For this purpose, the retentate is replaced by the starting oil, which has a TPA value of about 28%. If the permeate flux recovers and settles back to the value at the beginning of the experiment, the decrease can be attributed to the concentration gradient or to the increase in viscosity. However, if the permeate flux remains at a low level, it will be due to fouling.

3.4.3.2 Characterization GMT o-NF3

The GMT o-NF3 is characterized with further experiments. Three experimental runs are performed to evaluate the behaviour of the permeate flux and the retention factor at different pressure, oil temperature and overflow (test numbers oNF-3 53a-c). The process parameters used can be seen in Table 11.

As with the PERVAP 4060 membrane, the behaviour of the oNF-3 membrane during concentration is also to be characterized in a long-term test. For this purpose, a long-term experiment is carried out in which the TPAR is concentrated up to 50% (experiment number oNF3-53d). For this purpose, continuous filtration is performed over 187.3 h and a total of 62 samples are drawn and analyzed by FT-NIR. Permeate flux is also determined for each sample draw. In addition, the viscosity of the retentate is determined from every tenth sample and at the end of the experiment. As in the long-term test of PERVAP 4060, at the end of the test the retentate is replaced by the initial frying oil and filtered for a further two hours.

TABLE 11
Process parameters in the characterization
of the GMT o-NF3 membrane.

| | | | | |
|---|---|---|---|---|
| | Pressure | Oil temperature | Overflow | Running |
| Trial number | [bar] | [° C.] | [l/min] | time [h] |

Pressure dependence

| | | | | |
|---|---|---|---|---|
| oNF3-53a.1 | 10 | 70 | 6 | 1 |
| oNF3-53a. 2 | 15 | 70 | 6 | 2 |
| oNF3-53a. 3 | 20 | 70 | 6 | 1 |
| oNF3-53a. 4 | 25 | 70 | 6 | 1 |

Temperature dependence

| | | | | |
|---|---|---|---|---|
| oNF3-53b.1 | 20 | 60 | 6 | 1 |
| oNF3-53b. 2 | 20 | 70 | 6 | 1 |
| oNF3-53b. 3 | 20 | 80 | 6 | 1 |
| oNF3-53b. 4 | 20 | 90 | 6 | 1 |
| oNF3-53b. 5 | 20 | 50 | 6 | 1 |

Flow dependence

| | | | | |
|---|---|---|---|---|
| oNF3-53c.1 | 20 | 70 | 6 | 1 |
| oNF3-53c. 2 | 20 | 70 | 12 | 1 |
| oNF3-53c. 3 | 20 | 70 | 15 | 1 |
| oNF3-53c. 4 | 20 | 70 | 20 | 0.25 |

Concentration

| | | | | |
|---|---|---|---|---|
| oNF3-53d | 20 | 70 | 6 | 187.3 |

3.5 System design

In order to be able to use the membrane process specifically in a gastronomy deep fryer, a suitable process must be developed that takes into account the prevailing conditions and the objective. Based on the experience gained from the membrane filtration trials, expert discussions and in consultation with the industrial partner Gastrofrit AG, initial sketches of the process were drawn up and the process steps described individually. These sketches are to serve as a starting point at a later stage in the project in order to be able to implement membrane filtration in a new catering fryer in cooperation with a design engineer. All sketches are created with Microsoft Visio, version 2016.

### 3.6 Simulation

Based on the theoretically developed process, a simulation of the process will be created in a collaboration with the Institute for Applied Simulation (IAS) of the ZHAW, namely with Lukas Hollenstein. The aim is to be able to simulate the behaviour of the TPA values in the new process with different process parameters and thus generate information for the further prototypes.

The application “Jupyter” (version 5.5.0) from the software “Anaconda Navigator” (version 1.8.7) and the programming language “Python” are used. For this purpose, the process is defined and outlined. Based on this, the relationships of the system are expressed in mathematical formulas and programmed as a simulation. The mathematical foundations and the programming based on them are created by the IAS. The required information and parameters are generated and provided by the OLFO project team.

The following relationships and quantities are defined as the basis of the simulation:
Indices for subsystem i, j=1, . . . , n, with n=8
Volume: Vi [l]
Density: pi [g/ml]=[kg/l]
Flow rate from i to j: Qij [l/h]
Mass flow from i to j: qm, ij [kg/h]
TPA concentration (fraction): ci [1]
Filter factor from i to j: fij [1].
Time: t [h]

The following assumptions were made about the process for programming the simulation: Density oil=0.9 [g/ml]
Density TPA=0.95 [g/ml]
TPA Fresh oil=3 [% TPA]
Input French fries=15 [kg/h].
Oil absorption French fries=3 [%].
Oil spoilage rate
   In Stand-by Mode=0.085 [% TPA/h].
   When frying=0.4 [% TPA] (at 15 kg fries per hour and 9 liters of oil).
Circulation in the fryer=20 [l/h].
Frying times per day=11:00-14:00 and 17:00 to 21:00
   3.7 Frying Test with Prototype

The aim of this experiment is to find out how the spoilage characteristics of frying oil from a conventionally operated fryer (standard) compare with those of the prototype fryer. For this purpose, French fries and chicken nuggets are deep-fried over thirteen days to mimic as closely as possible a restaurant operation. As shown, TPA measurements vary from different standard tests. With its two separate frying basins, the prototype allows two batches of experiments to be run simultaneously. Thus, each experiment can be directly compared to a standard experiment under the same conditions. For this purpose, one frying basin is connected to the filter system, while the other, as standard, runs classically without filtration. The fryers are each filled with seven liters of Holl rapeseed oil.

The membrane filtration is run with a feed temperature of 70° C., a TMP of 20 bar and an overflow of 6 l/min. The membrane surface area is 0.236 m² (eight GMT oNF-3 membrane sheets of 0.0295 m²) and the feed tank is filled with three liters of fresh Holl rapeseed oil at the start of the experiment.

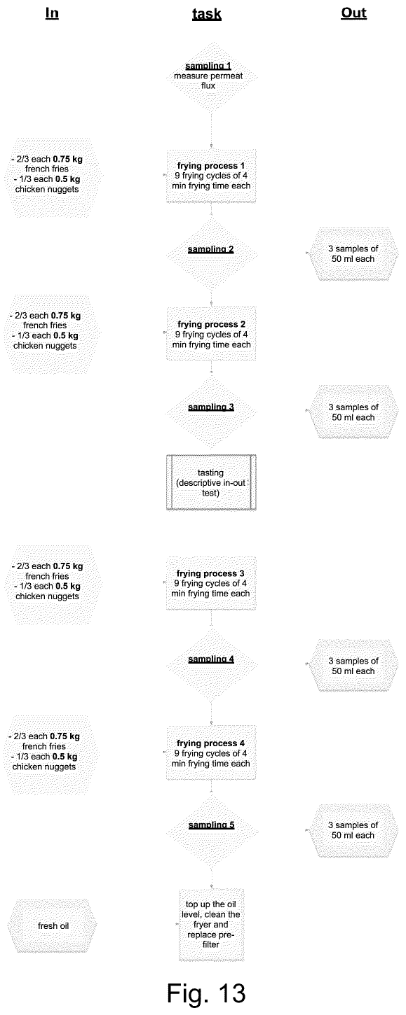

FIG. 13 shows the sequence of an experimental day, which is divided into two parts. This is to simulate the shutdown of the deep fryer after a lunch service. The fryer is thus operated twice for three hours per day. In each case, 0.75 kg of French fries or 0.5 kg of chicken nuggets are used per frying basket. Chicken nuggets are deep-fried in every third deep-frying process. The remaining frying processes are carried out with French fries. Both products are deep-fried for four minutes each. Every 90 minutes, frying oil samples are taken from the standard fryer, the retentate and the prototype. All samples drawn will be analyzed for spoilage characteristics using FT-NIR. Viscosity will be measured every third day and color will be recorded daily from the first and last samples. In addition, a descriptive in-out test will be performed daily after sample draw 2, which is intended to identify any sensory defects in the deep-fried fries and will be performed on the samples from sample draw 2. The sensory test is described in paragraph 4.2.7. At the end of a test day, the fryers are turned off, but the membrane filtration is left running overnight. Cleaning of the fryer and replacement of the pre-filter take place the next morning in each case.

To accelerate oil spoilage, cleaning is omitted in the last three days of the experiment, the temperature is increased to 175° C. and the frying frequency is reduced to four baskets of 500 g French fries or chicken nuggets per 90 minutes. The test procedure is recorded in the test form.

### 3.8 Risk Analysis

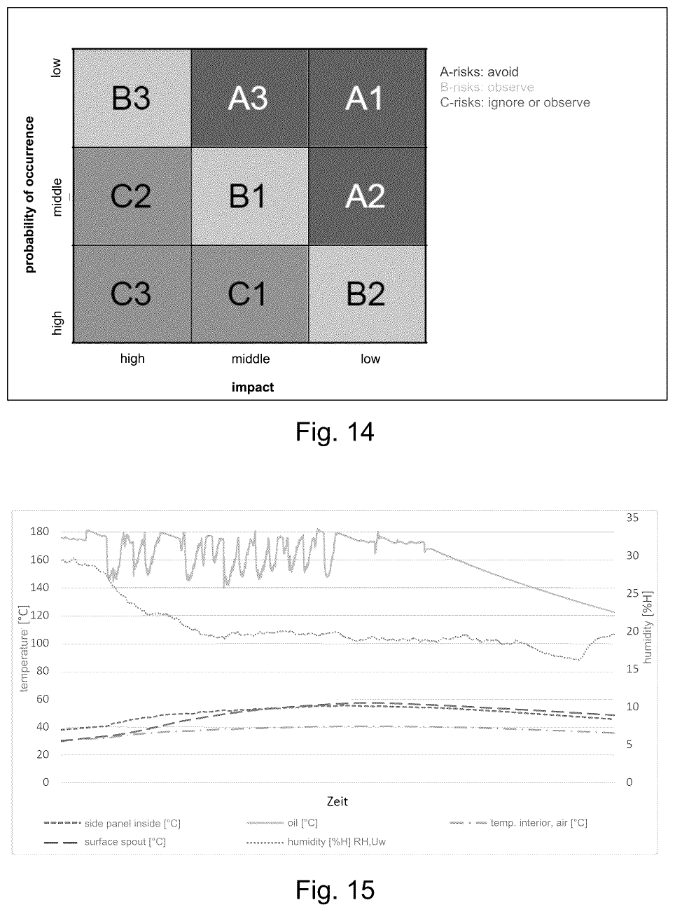

A risk analysis is performed to evaluate the potential risks that could jeopardize successful scale-up in the further course of the project. The matrix shown in FIG. 14 is used for this purpose. The risks are subdivided according to the risk dimensions mentioned in section 2.4.2.3 (SIC, correct 1.4.2.3) and evaluated with the risk matrix. In each case, the probability of occurrence and the severity of the impact are rated from one to three points. These scores are multiplied to calculate a risk factor for each identified risk. Possible countermeasures are defined for each risk.

### 4 Results

### 4.1 Process Analysis

The process analysis includes temperature measurements in a standard fryer and the mass balance of the membrane filtration.

### 4.1.1 Temperature and Humidity Measurements in Standard Fryer

FIG. 15 shows the measurement results of the four temperature probes and the humidity as a function of time. The air temperature inside the fryer reaches a maximum value of 40.5° C. (12:39 h). The surface temperatures reach their maximum at 55.2° (side wall, 12:45 h) and 57.1° C. (outlet, 12:47 h). The individual frying processes can be recognized by the temperature drops of the oil temperatures. However, it always remains below 182.4° C. In contrast to the temperature, the humidity inside the fryer decreases during the frying time. The highest value is measured before the first frying process at 29.7% H. The lowest value is 16.2% H.

### 4.1.2 Mass Balance During Membrane Filtration

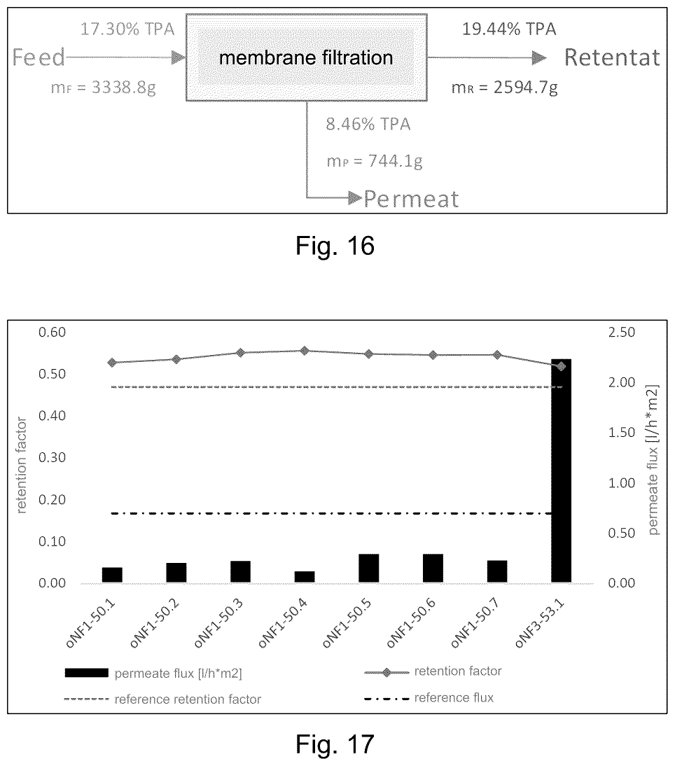

FIG. 16 shows the measured masses and TPA values. The TPAF is 17.30% (standard deviation (SD): 0.12), the TPAp is 8% (SD: 0.21) and the TPAR is 19.44 (SD: 0.21). The mass of frying oil in the feed is 3338.8 g and that of permeate is 744.1 g. This gives the calculated mass of concentrated retentate in the membrane system of 2594.7 g. Substituting this into formula 8 gives:

$$\\ x = 3338.8 g \cdot 0.17 - 2594.7 g \cdot 0.19 - 744.1 g \cdot 0.08$$

$$\\ x = 10.35 g$$

Thus, it can be seen that 10.35 g of polar fractions (1.7% of the total TPA in the feed) can no longer be detected after filtration and must be considered a loss.

### 4.2 Membrane Filtration

4.2.1 Membrane Filtration after Previous Fractionation

The hydrophilic as well as the hydrophobic membrane showed no permeate flux in the temperature range from −4 to 30° C. The TMP was 25 bar. After two hours without permeate flux, the experiment was stopped. Thus, no further results could be generated and membrane filtration of fractionated frying oil must be considered infeasible under these conditions.

### 4.2.2 Membrane Selection

The results of the preliminary tests for membrane selection are summarized in FIG. 17. The retention factor for all experiments ranges between 0.52 and 0.56, i.e. above the defined reference value of 0.47. The permeate fluxes of the experiments with the oNF-1 membrane are all below the reference value of 0.71/h·m². Only the oNF3-53.1 experiment shows a permeate flux of 2.2 l/h·m², which is 214% above the reference value.

### 4.2.3 Membrane Characterization

Membrane characterization was performed using both PERVAP 4060 and GMT oNF-3 membranes. The results of the tests performed are given in the following sections 4.2.3.1 and 4.2.3.2.

### 4.2.3.1 Pervap 4060

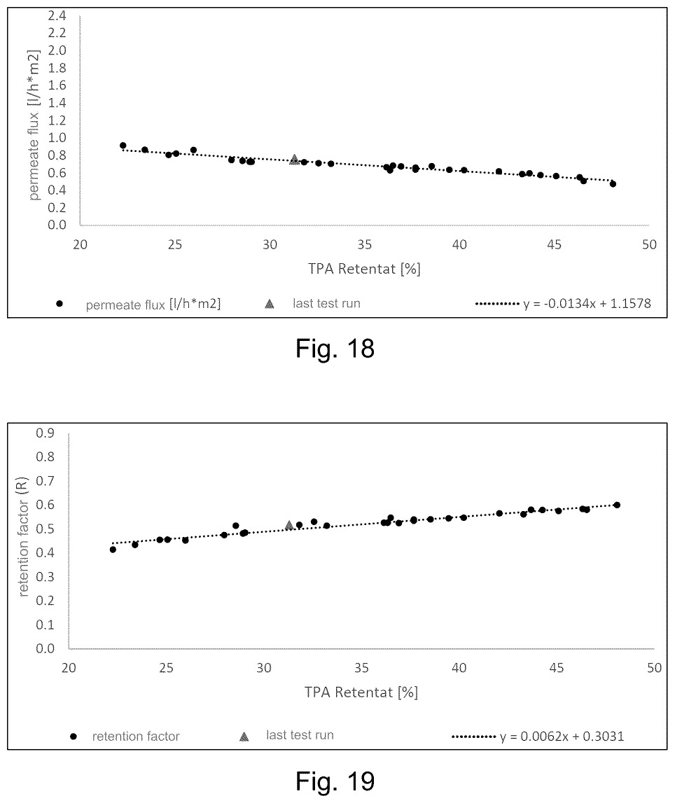

FIG. 18 shows that the permeate flux decreases with increasing TPA_{R}. Thus, at the beginning of the experiment and a TPAR of 22.3% it is 0.92 l/h·m² and at the end of the experiment (TPA_{R}: 48.1%) it decreases by 48% to 0.47 l/h·m².

The permeate flux at the last experimental run, where the retentate was replaced with the starting frying oil (TPA_{R}: 31.31%), is 0.76 l/h·m² and thus in the range of the regression line.

At the same time, it can be observed that with increasing TPA_{R}, the TPA_{P} also increases. The values of the TPA_{P} range between 13.05% and 19.24%. Thus, as shown in FIG. 19, the retention factor also changes. If it is still 0.41 for TPA_{R}, it increases from 48.1% to 0.60 for TPA_{R}. Like the permeate flux, the retention factor of the last test run is in the range of the regression line at 0.52.

4.2.3.2 GMT oNF-3

For the sake of clarity, the results of the individual characterization tests with the GMT oNF-3 membrane are divided into the investigated parameters of pressure, temperature and overflow. In addition, the long-term test, whereby the retentate should be concentrated, is listed individually.

Pressure (oNF3-53a)

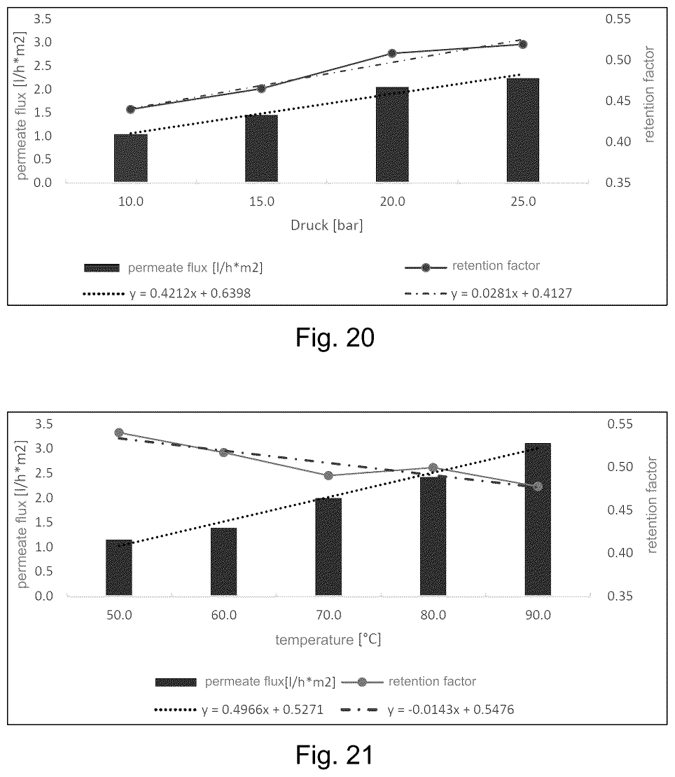

FIG. 20 shows that the retention factor and the permeate flux increase with increasing pressure. At the lowest tested TMP of 10 bar, a permeate flux of 1,034 l/h·m² was measured, with a retention factor of 0.44. At twice the TMP of 20 bar, the permeate flux also almost doubled to 2,051 l/h·m². The retention factor also increases with increasing TMP. Thus, at 10 bar it is 0.44 and increases to 0.52 at 20 bar.

Temperature (oNF3-53b)

As the temperature increases, the permeate flux increases and the retention factor decreases simultaneously. FIG. 21 also shows that the highest permeate flux of 3.12 l/h·m² is measured at a temperature of 90° C.

Overflow (oNF3-53c)

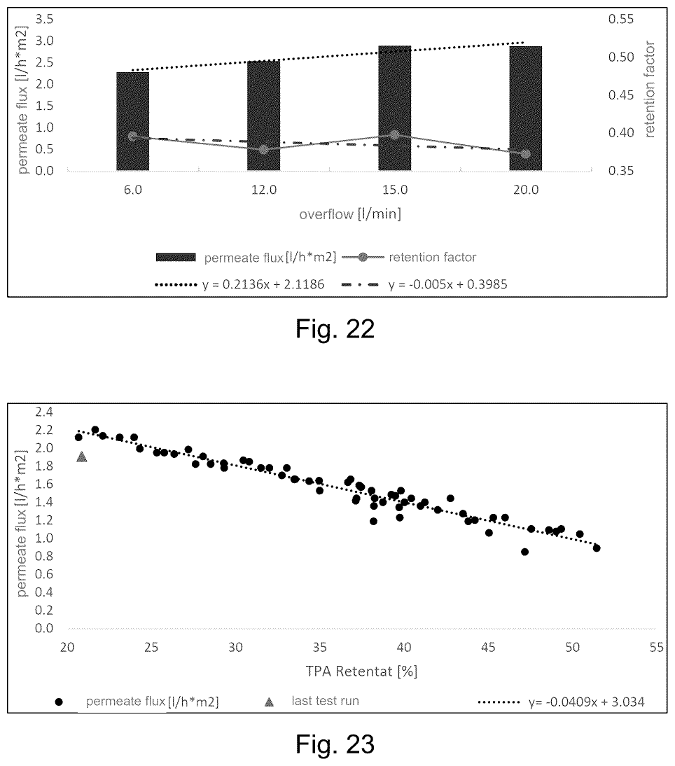

FIG. 22 shows the following: The flow rate slightly influences the permeate flux. It increases from 2.29 l/h·m² at a flow rate of 6 l/min to a maximum permeate flux of 2.90 l/h·m² at 15 l/min. If the volume flow is increased to 20 l/min, the permeate flux decreases insignificantly to 2.88 l/h·m².

### Long-Term Test

In the long-term test, a clear tendency of the permeate flux in relation to the TPA_{R} can be seen. The higher the TPA_{R}, the lower the permeate flux. This relationship is shown as a regression line in FIG. 23 and can be described by the function y=−0.0409x+3.034. The coefficient of determination here is R²=0.9377. The measured permeate flux of the last experimental run is 1.90 l/h·m², which is slightly lower than the expected value of 2.18 l/h·m² calculated by the regression line.

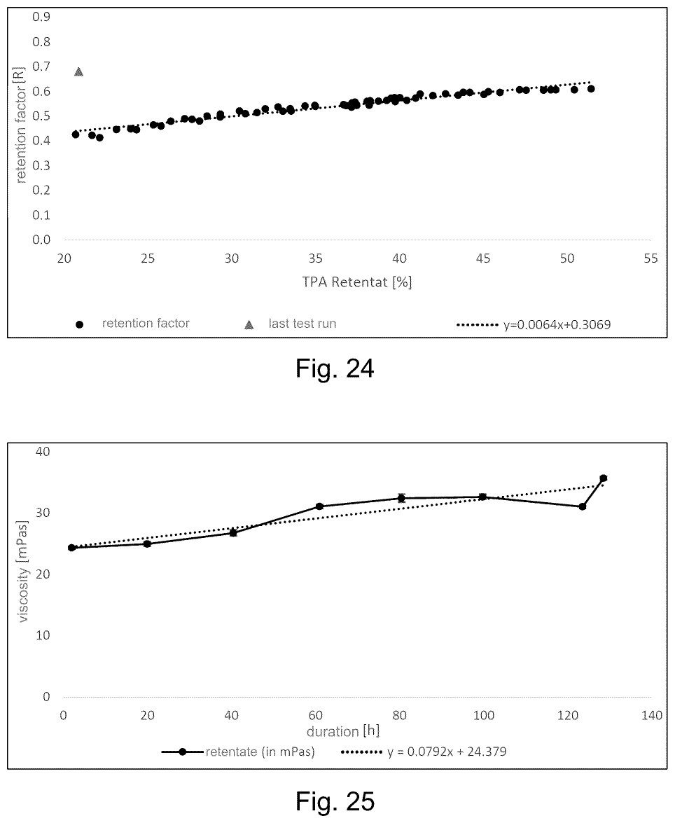

The TPA_{P} increases with an increase of the TPA_{R}. With a TPA_{R} of 20.70%, a TPA_{P} of 11.89% is measured. If the TPA_{R} increases to 51.45%, the TPA_{P} is already 20.06%. This means that the retention factor also changes, which can be seen in FIG. 24. The retention factor is 0.43 for TPA_{R} and increases up to a maximum of 0.61. The regression line can be described by the function y=0.0064x+0.3069 and a coefficient of determination of R²=0.9489. The retention factor calculated with this for the last experimental run is 0.44. The measured value of 0.68 is higher than the value to be expected by the regression line.

### Viscosity

The dynamic viscosity of the frying oil at the start of the test and a temperature of 70° C. is 24.35 mPa·s. As can be seen in FIG. 25, the viscosity increases to 31.08 mPa's and remains in this range until sample number 53d.60 (about 60 h). At the end of the test, the retentate has a dynamic viscosity of 35.70 mPa's, which represents an increase over the entire course of the test of 11.35 mPa·s.

Based on the tests carried out, the following conditions can be defined which achieve the best separation results with the highest permeate flux for the specific application with the GMT oNF-3.
TMP: 25 bar
Overflow: 15 l/min
Temperature: 80° C.
TPA in retentate: <45%.

### 4.3 System Design

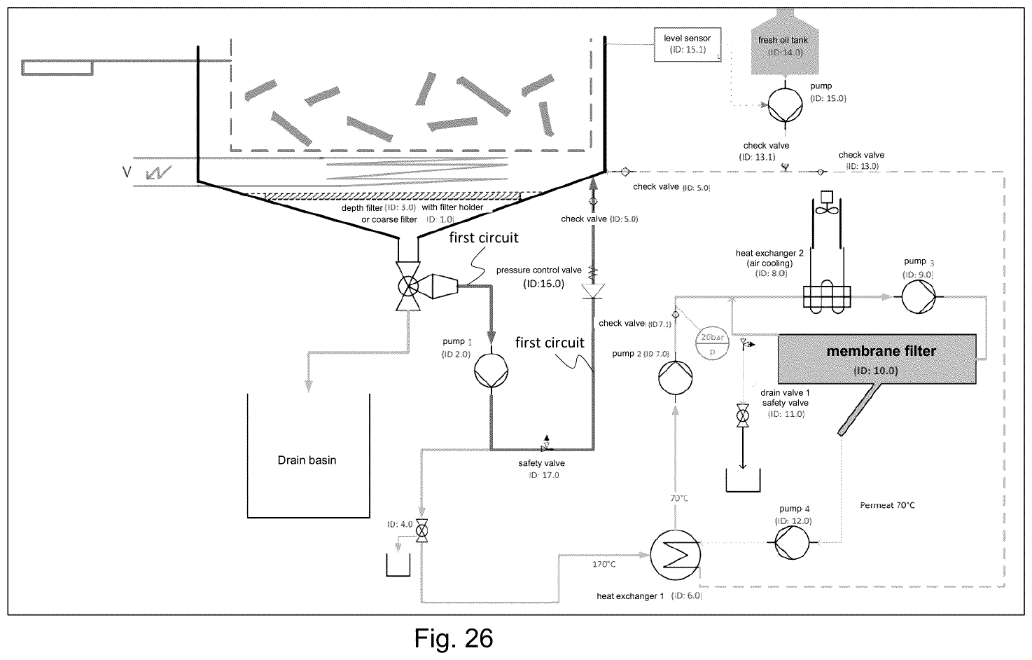

FIG. 26 shows the process sketch of the new OLFO deep fryer. It is based on two filter circuits and a pre-filter directly in the frying basin. The first circuit (green) leads from the frying basin via the depth filter and back into the fryer. This circuit is driven by pump 1 with an expected flow of 20 l/h. The second circuit includes membrane filtration and is shown in yellow. Here, a partial flow of the first circuit is used to feed frying oil pre-filtered by the depth filter into the membrane circuit. Due to a slight overpressure in circuit 1, which is maintained by the pressure maintaining valve (ID: 16), oil flows into circuit 2 by opening the valve (ID: 4). The frying oil is cooled by a heat exchanger to the temperature required for membrane filtration and the defined pressure is built up by pump 2 (approx. 0.4 l/h). The pressure in the membrane system is maintained with a check valve and pump 3 conveys the frying oil in the membrane circuit with a volume flow of 170 l/h. The heat energy generated is to be dissipated with a heat exchanger. The resulting heat energy is to be dissipated with the heat exchanger 2. In order to be able to drain the membrane circuit, the drain valve 1 or the safety valve is provided.

The resulting permeate is fed back into the fryer via heat exchanger 1 without pressure. The same connection is also intended to automatically replace the oil loss caused by the discharge with the product in the deep fryer with fresh frying oil. For this purpose, a level sensor (ID: 15.1) is used to control the pump of the fresh oil tank (ID: 15.0).

### 4.4 Simulation

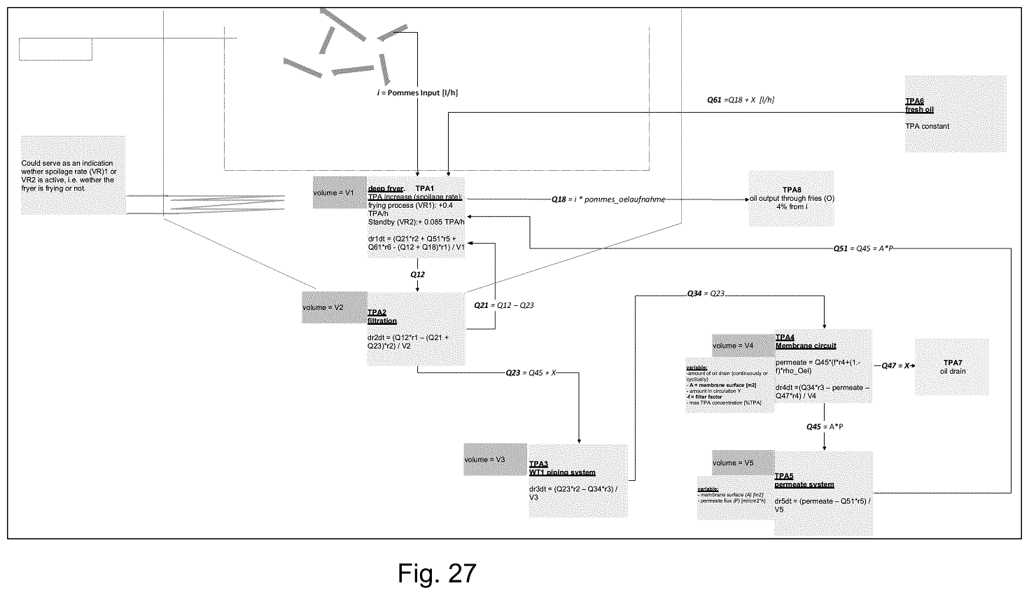

An overview of the relationships established is provided in FIG. 27.

The simulation calculates on the one hand the TPA concentrations [%] of the subsystems: Fryer, permeate system and membrane circuit and on the other hand the resulting volume of the consumed fresh oil as well as the oil waste and the oil output by the French fries over time. Parameters such as the membrane area, filter factor, permeate flux and volume in the membrane circuit remain variably adjustable.

The tests from section 4.2.3.2 showed that if the concentration of retentate in the membrane system is too high, the filtration performance decreases. For this reason, the retentate must be drained from the membrane system at a certain point in time in order to keep the system stable. For this purpose, the simulation considers two possible process designs, which can be simulated individually.

Continuous Oil Drain from the Retentate Circuit:

Here it is assumed that the retentate is drained at a variably adjustable, more constant oil drain rate. To prevent the discharge of perfect frying oil, a threshold value of the TPA_{R} is defined, above which the discharge is started.

### Cyclic Oil Drain

Cyclic oil draining assumes that the diaphragm circuit, i.e. the retentate, is completely drained twice a day.

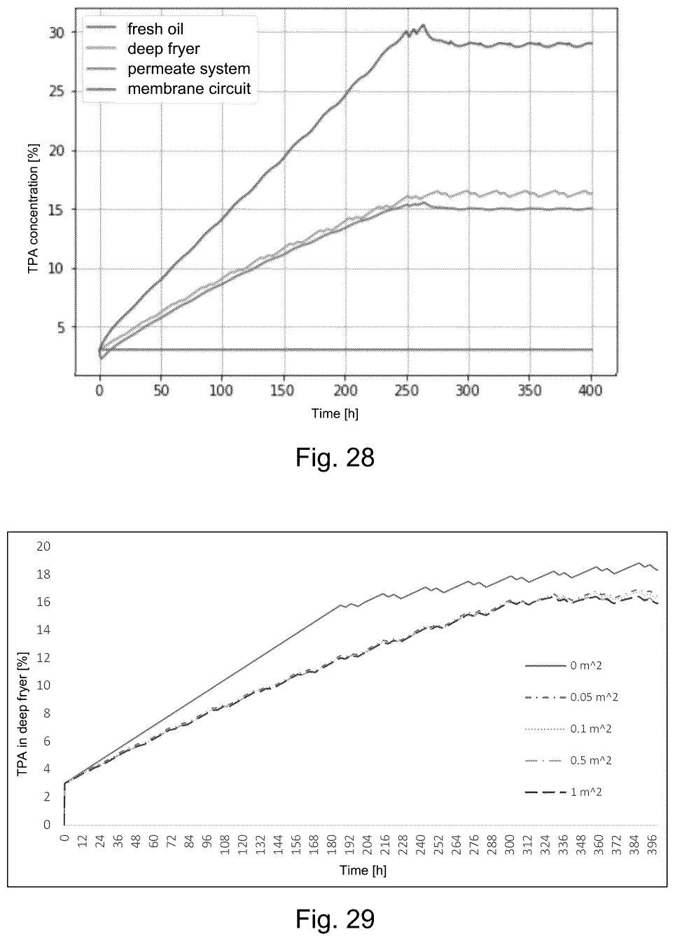

FIG. 28 shows a section of the simulation. The process is simulated over 400 h and the graph shows the TPA concentrations in the individual subsystems. The permeate flux is determined to 1.20 l/h/m² and the membrane area to 0.24 m². It can be seen that the TPA concentration in the fryer and that of the permeate system converge. Since the threshold is set at 16% TPA and thus retentate is discharged from the circuit at this TPA content and above, a flattening of the curves is evident at this point. The concentration of the membrane circuit, i.e. the retentate, increases and rises to a maximum of 31% TPA in the defined period.

FIG. 29 shows the influence of the membrane area on the TPA curve in the fryer. It can be seen that already from a small membrane area of 0.05 m² an effect sets in, which changes only slightly when the membrane area is increased. Thus, the TPA after 400 h with a membrane area of 0.05 m² is 16.48%. If the membrane area is increased to 1 m², the TPA at the end of the 400 h is 15.95%.

4.5 Frying Test with Prototype

### 4.5.1 NIR Analysis

The FT-NIR measurements yielded values for TPA, SZ, AnZ and polymeric triglycerides (PTG). In the following sections, the values of the individual spoilage indicators are shown and the calculated DEGLEV is also presented.

### 4.5.1.1 TPA

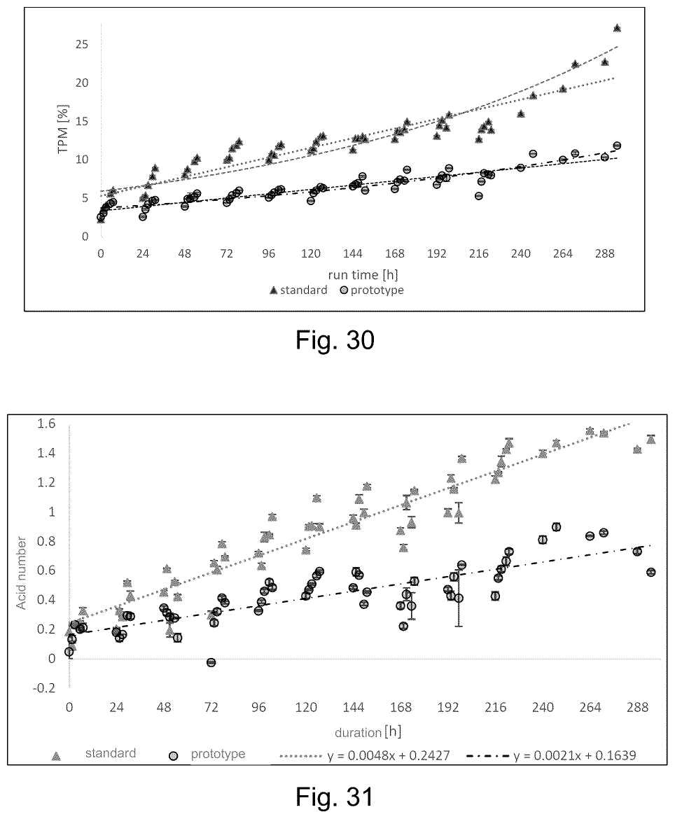

As can be seen in FIG. 30, the TPA values of the prototype are lower than those of the standard fryer over the entire course and also increase more slowly. This can be seen in the slope of the two linear regression lines. Thus, the slope of the standard is 0.052 and that of the prototype is 0.023.

The residuals of the FT-NIR measurements for the TPA are on average 11-12%, the standard deviation on average below 0.1 and overall never above 0.4.

The regression lines have coefficients of determination R² of 0.847 for the standard and 0.842 for the prototype. At the end of the experiments, the TPA of the standard is 27.18 and the TPA of the prototype is 11.84. At the same time, the TPA of the retentate is 12.99. The Kruskal Wallis test for the entire data series yields p-values of >0.002 and thus shows significant differences between all three test series (α=0.05).

### 4.5.1.2 Acid Value

The acid numbers of the measured frying oil samples from the standard and prototype fryers are shown in FIG. 31 as a function of the running time. As with the TPA, the standard fryer has a higher acid number than the prototype over the entire runtime. The slope of the regression line of the standard fryer is also 0.0048, which is higher than the slope of the prototype, which is 0.0021 (R²=0.9033 and 0.6852 for the prototype). The acid number at the end of the tests is 1.50 for the standard and 0.59 for the prototype. The acid number of the retentate at the same time is 0.54. The residual of the acid number NIR measurements is on average less than 10%. According to the Kruskal-Wallis test, the data series of the standard, retentate and prototype are significantly different (α=0.05).

### 4.5.1.3 Anisidine Number

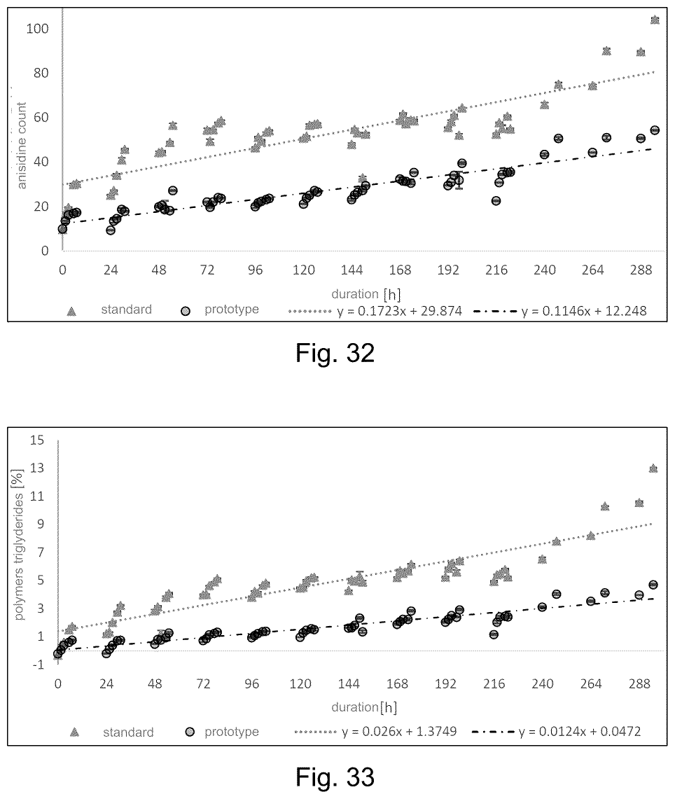

The mean residual of the anisidine number measurements is 18%. The regression lines show a slightly different slope. That of the standard is 0.172 and that of the prototype is 0.115. The initial values are 9.67 for the standard and 9.87 for the prototype, respectively, and increase to 104.38 and 54.38. The coefficient of determination of the regression line from the standard is R²=0.681 and that of the prototype R²=0.838. According to the Kruskal-Wallis test, the data series from the standard, retentate and prototype also show a significant difference here (α=0.05). FIG. 32 shows the course of the anisidine number of the standard and prototype over the course of the experimental time.

### 4.5.1.4 Polymeric Triglycerides

As can be seen in FIG. 33, the PTGs are higher for the standard than for the prototype and the regression line shows a larger slope. Thus, the final value of the standard is 13.03% and the slope is 0.026. For the prototype, the values are 4.70% and 0.012 slope, respectively. According to the Kruskal-Wallis test, there is a significant difference of all three sample series, standard, retentate and prototype (α=0.05).

### 4.5.1.5 DEGLEV

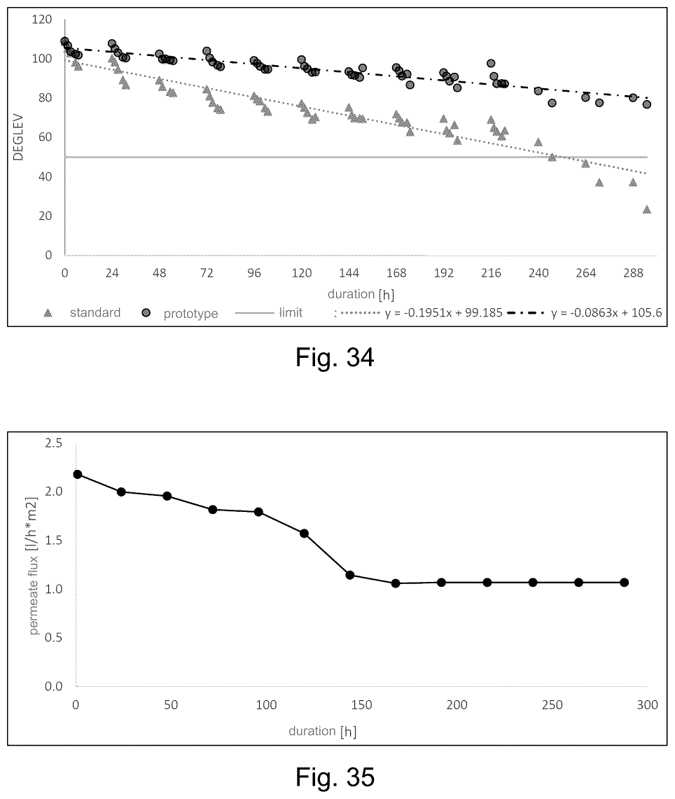

The DEGLEV calculated from formula 5 is shown for the standard and prototypes in FIG. 34. The limit value, which indicates when a frying oil is considered to be spoiled, is set at 50 and is indicated by a green line in FIG. 34. The frying oil of the prototype does not fall below this limit during the entire test and has a DEGLEV of 76.76 after 295 hours of operation. The frying oil of the standard fryer falls below the limit on the twelfth day of the test after 264 hours of operation and has a value of 23.49 at the end of the test.

### 5.5.2 Permeate Flux

The permeate flux at the beginning of the test is 2.18 l/h m². In the course of the test, it decreases and settles between 1.00 and 1.10 l/h m². FIG. 35 shows the permeate flux during the frying test.

### 4.5.3 Viscosity

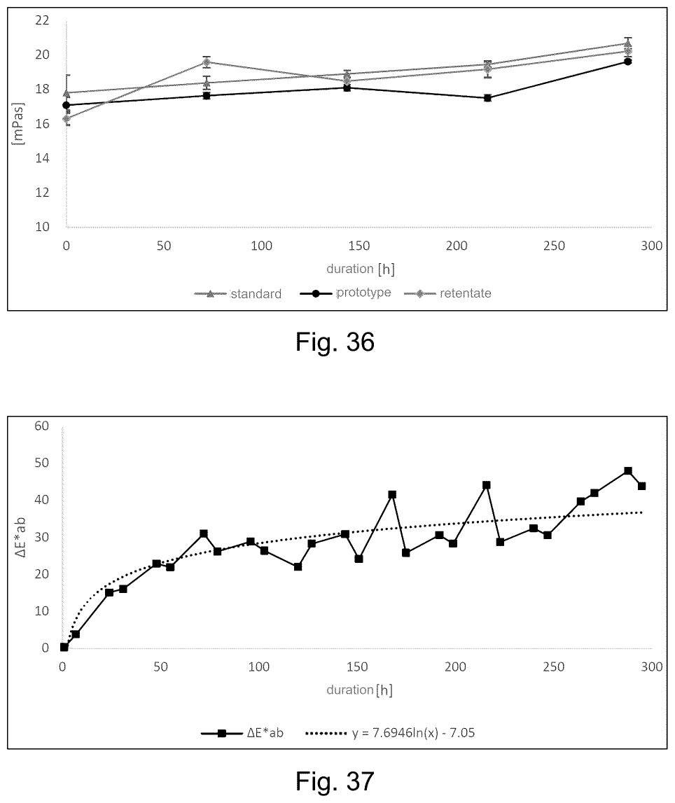

FIG. 36 compares the samples from the standard, prototype and retentate. Different progressions of the viscosity curves are evident. The last samples measured after 288 h all show a viscosity in a range between 19.62 and 20.68 mPa·s. The Kruskal-Wallis test over the entire samples yields the p-values shown in Table 12 and thus a significant difference between the frying oil from the standard fryer and the frying oil from the prototype and the retentate (α=0.05).

TABLE 12
P values of the Kurskal-Wallis test over the entire viscosity curve

| Sample | Standard | Prototype | Retentate | Groups |
|---|---|---|---|---|
| Standard | 1 | 0.003 | 0.074 | A |
| Prototype | 0.003 | 1 | 0.019 | B |
| Retentate | 0.894 | 0.019 | 1 | B |

### 4.5.4 Color

To quantify the color difference between the standard and prototype, the color difference ΔE*ab was calculated using Formula 1 and shown in FIG. 37. It shows a significant increase in ΔE*ab from 0.24 to 43.83 and can be described by the function y=7.5007 ln(x)−6.0945 and R²=0.7378.

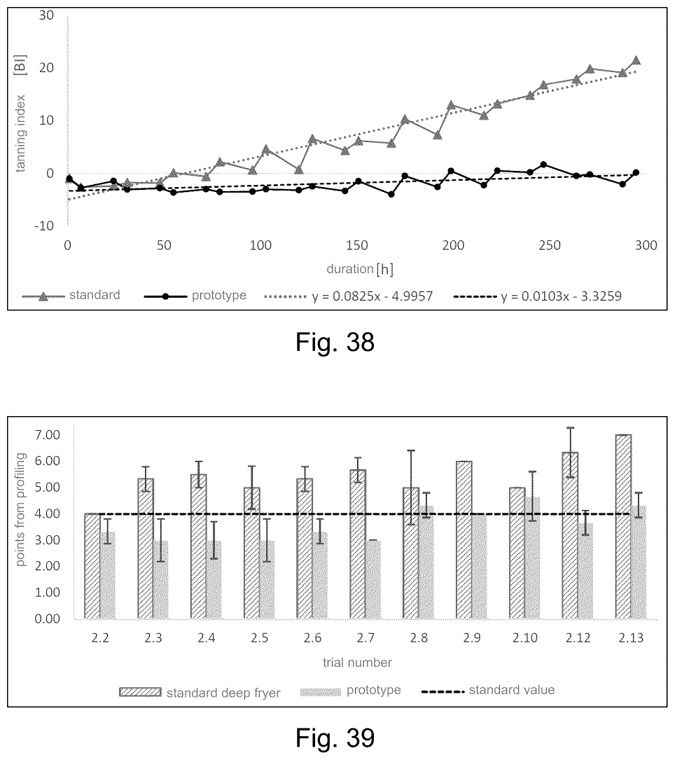

The browning index (BI) is shown in FIG. 38. All measurements are in the negative range at the beginning of the test. While the BI of the standard and retentate increase over time to 21.55 and 15.25, respectively, the BI of the prototype remains mostly below zero and increases to a maximum of 1.71. The differences become additionally visible by the linear regression line. That of the prototype shows a slope of 0.0103, that of the standard one of 0.0825.

### 4.5.5 Sensors

The in-out test did not reveal any “out” rating for the French fries. The French fries are therefore rated as edible throughout the entire test. The frying oil of the standard fryer is rated as “just out” by 33% of the testers (=one tester) on test day 6 and by 67% (=two testers) on test day 13. On the remaining trial days, 100% of the ratings are “in” or “just in” for the standard product. The values for test day 1 and 11 are missing due to an insufficient number of testers.

The results of the descriptive part of the in-out test are summarized separately for the frying oil and the French fries in the following sections. Here, the focus is on the most striking attributes.

### 4.5.5.1 Frying Oil

### Appearance—Color Intensity

FIG. 39 shows the perceived color intensities from the standard fryer and the prototype. That of the prototype oil is mostly rated weaker than that of the standard fryer oil. It is below the defined standard value up to test number 2.8. Taking into account the standard deviation, no differences in color intensity can be detected on test day 8 and 10.

### Odor—Rancid

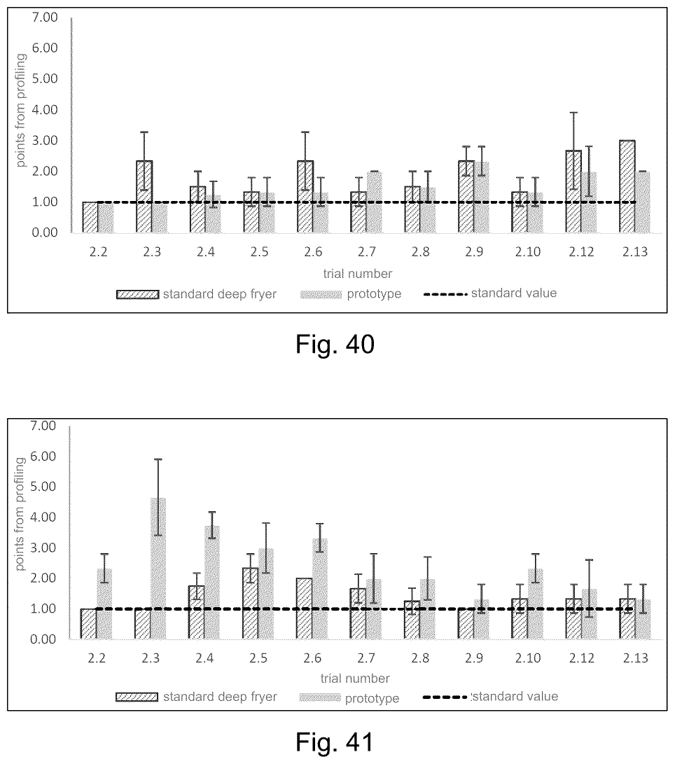

The frying oil of the standard deep fryer is already perceived as slightly rancid on the third day of the test. Clear differences between the two oils can only be seen at test number 13, where the rancidity of the prototype frying oil is rated at two points and that of the standard fryer at three points. FIG. 40 shows the evaluation of olfactory rancidity in the descriptive in-out test of the oils from the standard deep fryer and prototype.

### Odor—Fishy

FIG. 41 illustrates, that the frying oil of the prototype is initially perceived as fishy. However, this perception decreases in the course of the test. At the end of the test series, the attribute “fishy” is only weakly perceived olfactorily by one test subject.

### Taste—Rancid

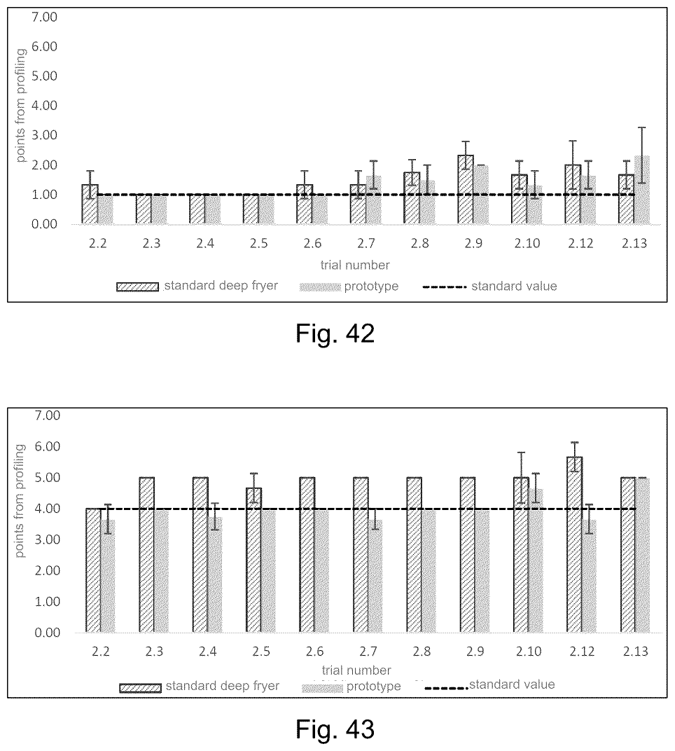

At olfactory perception, the frying oils are judged to be rancid for the first time on the seventh day of the test. As can be seen in FIG. 42, taking into account the standard deviation, no clear differences between frying oil from the standard fryer and frying oil from the prototype can be detected during the entire series of tests.

### 4.5.5.2 French Fries

### Appearance—Gold-Brown Coloring

The fries of the standard fryer are perceived as more intense in their golden-brown coloration than those of the prototype. At the end of the test series, the attribute is rated with five points for both frying oils. FIG. 43 shows the assessment of the gold-brown coloration in the descriptive in-out test of the French fries from the standard fryer and prototype.

### Odor—Rancid

The attribute rancidity in French fries is not perceived on the ofactic level until test day 11. On test days 11 and 12, the French fries from the standard deep fryer are each awarded two points by one test person.

### Taste—Roasty

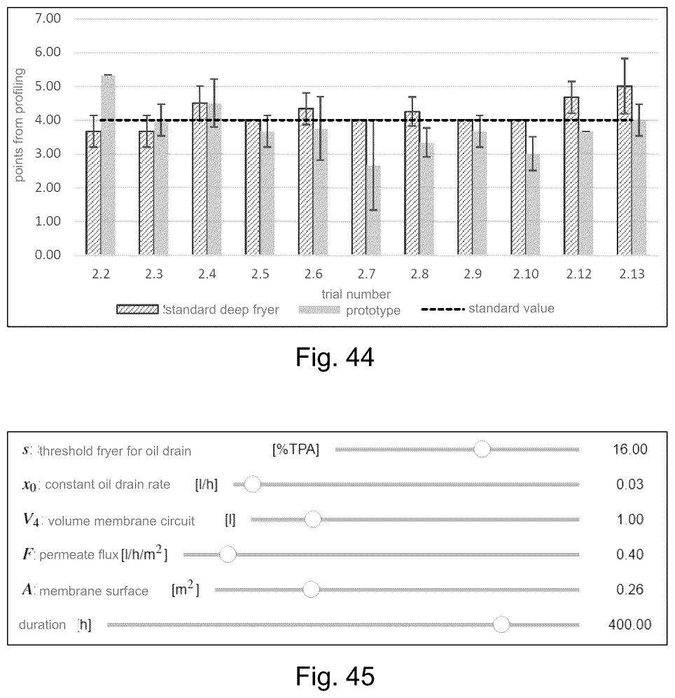

The attribute Roasty does not show any clear tendencies in FIG. 44. It is mostly perceived in the range of the standard value. However, in test numbers 2.8, 2.10 and 2.12, there is a stronger perception of the toastiness of the French fries from the standard deep fryer. At the end of the test series, no more differences can be seen, taking the standard deviation into account.

### 4.6 Risk Analysis

Table 13 shows the overview of the risk analysis. The risk of the lack of a declaration of conformity is classified in the risk dimension “Economy” and has the highest risk factor. The A risks also include excessive production costs and lack of economic resources for further research. These two risks in the economic dimension are each rated with a risk factor of 6. They can be controlled and monitored, but would have a major impact on the further course of the project.

TABLE 13
Risk assessment based on six risk dimensions.

| Risk | | | | Risk | possible |
|---|---|---|---|---|---|
| dimension | potential risk | Probability | Impact | factor | countermeasures |
| Health | Pollutants accumulate | 2 | 2 | 4 | In field trials, frying |
| | in the frying oil | | | | oil samples should be |
| | despite decreasing | | | | analyzed for |
| | TPA and thus enter | | | | contaminants such as |
| | the final product. | | | | acrylamide. |
| | Membrane does not | 3 | 3 | 9 | Direct communication |
| | receive a declaration | | | | with GMT and offer to |
| | of compliance for | | | | meet in person if |
| | food contact. | | | | necessary. Parts of the |
| | | | | | compliance work could |
| | | | | | be taken over by the |
| | | | | | project, for example. |
| Environment | energy consumption | 1 | 2 | 2 | Consider energy |
| | too high, so that | | | | consumption from the |
| | saving oil no longer | | | | very beginning of the |
| | makes sense from an | | | | system design. |
| | environmental point | | | | |
| | of view. | | | | |
| Social | Acceptance by | 1 | 1 | 1 | Communicate that no |
| | consumers is non- | | | | additives are used and |
| | existent. | | | | that the process is based |
| | | | | | on a purely physical |
| | | | | | separation process and |
| | | | | | produces flawless |
| | | | | | products. |
| Economy | Production costs | 2 | 3 | 6 | Perform cost calculations |
| | exceed the | | | | early in system design, |
| | economically | | | | monitor regularly, and |
| | justifiable limit. | | | | take action if necessary. |
| | | | | | Take measures to reduce |
| | | | | | costs. |
| | Lack of economic | 2 | 3 | 6 | Communicate the |
| | resources to continue | | | | available project budget |
| | the project or | | | | and monitor it. Monitor |
| | development costs | | | | project planning on an |
| | exceed the project | | | | ongoing basis and inform |
| | budget. | | | | project partners in case |
| | | | | | of uncertainties or |
| | | | | | bottlenecks. |
| Security | Lines or hoses give | 1 | 3 | 3 | All safety regulations |
| | way to the high | | | | must be observed and |
| | pressure or the | | | | only materials that can |
| | necessary safety | | | | withstand the |
| | certificates are not | | | | temperature and pressure |
| | issued. | | | | conditions must be used. |
| | | | | | The necessary safety |
| | | | | | measures should be |
| | | | | | known and documented. |
| Technology | Pump procurement | 2 | 2 | 4 | Contact different |
| | with the necessary | | | | suppliers early, identify |
| | requirements proves | | | | similar applications and |
| | impossible. | | | | evaluate their pumps. |
| | The heat inside the | 2 | 2 | 4 | Where possible, pipes |
| | fryer could stress or | | | | are insulated and |
| | damage the controls. | | | | ventilation is installed if |
| | | | | | necessary. |
| | The system does not | 2 | 2 | 4 | Define the design of the |
| | fit into a deep fryer. | | | | new fryer so that the |
| | | | | | process is optimized and |
| | | | | | uses as few materials as |
| | | | | | possible (reduce to the |
| | | | | | max). The filter system |
| | | | | | can also be developed as |
| | | | | | an external tool if space |
| | | | | | is too limited. |
| | Cleaning the entire | 2 | 1 | 2 | The handling of cleaning |
| | system is beyond the | | | | should be considered at |
| | expertise of the | | | | the system design stage |
| | operator and is too | | | | and all parts should be |
| | costly for everyday | | | | designed so that they can |
| | use, making the fryer | | | | be cleaned with little |
| | unattractive to | | | | effort. The membrane |
| | customers. | | | | module could also be |
| | | | | | replaced by the service |
| | | | | | technician and cleaned |
| | | | | | externally. |
| | The system does not | 3 | 1 | 3 | Due to the different |
| | consistently perform | | | | frying media and goods, |
| | the same. Since there | | | | different conditions |
| | are many new process | | | | prevail in each case. The |
| | steps in the system, it | | | | equipment should |
| | is still difficult to | | | | therefore be tested in |
| | predict how it will | | | | broad field trials |
| | work. | | | | (SVGroup). In this way, |
| | | | | | the fryers can be adjusted |
| | | | | | to the individual |
| | | | | | conditions of each |
| | | | | | customer. |
| | Solids in the system | 3 | 1 | 3 | Sufficient attention |
| | cause malfunctions | | | | should be paid to |
| | and failures. | | | | prefiltration during the |
| | | | | | further development |
| | | | | | phase to exclude any |
| | | | | | particles in the rest of the |
| | | | | | system and to ensure |
| | | | | | optimum prefiltration. |

### 5 Discussion

Conclusions for a successful continuation of the scale-up will be drawn and pointed out from the results obtained in the following section.

5.1 General procedure

The work carried out can be mirrored for the most part by the structure of a concept design shown in the theory section (Section 1.4.2, FIG. 4). The definition of the objective was carried out prior to this work and was therefore not considered in more detail. Membrane selection was performed and is discussed below.

The next steps according to FIG. 4 are to determine the system parameters and to perform module tests. These steps were performed with the process analysis (section 5.2) and the membrane characterizations (section 5.3). During the pilot tests, the selection of the configuration of the membrane elements should already be carried out (See also section 1.4.2.1).

The membrane characterization provided important data to start the system design and to map the developed process in a process simulation. The simulation then showed how the various system parameters affect the TPA and the frying oil consumption.

With the design and construction of the first prototype and the frying tests carried out with it, an initial evaluation of the system has been made, which is discussed in Section 5.6.

The risk analysis discussed in Section 5.7 should be followed and regularly updated during system design optimization.

In general, it can be noted that throughout the system design, the involvement of a designer is beneficial. The designer should have the following competencies:
Can map the process professionally
Can assess the feasibility
Can design and implement a systematically constructed prototype

Although a primary evaluation of the system could be performed with the construction of the prototype described in this thesis, it was only an approximation or simplification of the envisioned process. In order to be able to develop and test a closed system on a scale that is realistic for the end application in the future, this external contribution to the design work is indispensable.

### 5.2 Process Analysis

### 5.2.1 Temperature and Humidity Measurements in a Standard Deep Fryer

The fryer was in use in a normal lunch service where French fries were produced. The test conditions can therefore be regarded as very close to practice. However, the measured temperatures were lower than expected. In the run-up to the measurements, it was suspected that temperatures of over 100° C. would prevail inside the fryer, which would influence the design of the materials to be used in the new OLFO fryer. However, since the temperatures of the surfaces did not exceed 60° C., they posed little problem for process engineering. However, it should be noted that in a planned new development, frying oil with temperatures of up to 180° C. will flow through lines in the interior of the fryer and this can lead to significantly higher ambient temperatures.

Since a large part of the geometrical deviations on workpieces in machines are due to temperature influences, sufficient attention should be paid to the prevailing temperatures when developing a closed prototype fryer and the materials should be selected accordingly.

### 5.2.2 Mass Balance During Membrane Filtration

It is assumed that no mass is lost in the membrane system. The analyzed TPA contents of the permeate and retentate should therefore theoretically balance out with the TPA_{F}. Thus, the mass balance can be used to detect unexpected changes in the product during the membrane separation process.

In mass balance studies of membrane filtration (PERVAP 4060) with frying oil, a TPA loss of 29.5 g was found during one hour of filtration. However, the filtration time was only 60 min, which led to only a slight difference in TPA_{F} and TPA_{R} due to the low permeate flux. This small difference in turn increases the influence of possible measurement inaccuracies in the TPA analysis on the mass balance. In order to minimize this influence, the filtration time was increased in this experiment and thus the delta between TPA_{F} and TPA_{R} was also increased in order to obtain more reliable results.

The results of this experiment showed, with a TPA loss of 10.35 g, a loss of 1.79% of the initial TPA in the feed. Now, it could be concluded that changes occur in the frying oil during filtration. However, since oxidation or degradation processes can also occur during filtration, an increase in TPA would rather have been expected. Therefore, the small percentage loss of 1.79%, is rather due to measurement inaccuracies of the analytics. From the mass balance it is therefore concluded that no changes in the concentrations take place during membrane filtration or that no mass of TPA is created or lost.

### 5.3 Membrane Filtration

Before the individual experiments are discussed in detail in the subsections, this part deals with the general overview and discussion of the membrane experiments.

It was found that the oNF-3 membrane from GMT Membrantechnik GmbH is best suited for use with frying oil. Compared to the PERVAP 4060, it has a significantly higher permeate flux with a similar retention factor. Since a larger membrane area would be required for the PERVAP 4060, the GMT oNF-3 will be used in the further course of the project.

If the performance of the membranes is compared with the literature, it becomes apparent that the permeate flux of both tested membranes is still below the performance of a standard membrane application. The permeate flux of a typical NF application is 20-50 l/m² h (5-20 bar), which is ten times higher than the tested membranes.

In summary, the following dependencies, shown in Table 14, became apparent for the characterized membranes.

TABLE 14
Summary of the influences of the different process parameters
in the tests with the GMToNF-3 and the PERVAP 4060.
Influences of the process parameters

| | | |
|---|---|---|
| Parameter | Permeate flux | Retention factor |

| | | | |
|---|---|---|---|
| Print | high | rises ↑ | rises ↑ |
| | deep | decreases ↓ | decreases ↓ |
| Temperature | high | rises ↑ | decreases ↓ |
| | deep | decreases ↓ | rises ↑ |
| Overflow | high | rises a little ↑ | no effect |
| | deep | decreases a little↓ | no effect |
| TPAR | high | decreases ↓ | rises ↑ |
| | deep | rises ↑ | decreases ↓ |

In fact, there is no declaration of conformity for the GMT oNF-3 for use in foodstuffs. However, this is essential for the commercial use of the membrane with food contact.

The permeate flux of the characterization tests was measured over a filtration period of one hour in each case to compensate for short-term fluctuations during the measurements. However, confirmatory experiments would be necessary for results with statistically validated values.

Although used frying oil from the same restoration company was used in all tests, the starting oils of the individual tests are not always identical due to the different influences during frying. Therefore, the absolute values of the tests should be compared with caution and the focus should be on the course of the tendencies.

5.3.1 Membrane Filtration after Previous Fractionation

As already seen in section 3.4.1, the aim of this experiment was to separate the fat crystals that are formed during fractionation in the Contherm. One difficulty was to keep the frying oil at the desired −4° C. until it reached the ceramic module. The ceramic membrane with 5 nm pore size was chosen as the membrane because it had the highest flux in previous experiments (but no retention of TPA). It was assumed that this would allow the fat crystals to be retained and polar fractions to separate through the membrane.

The results showed no flux at all with this experimental setup. Thus, no further results could be generated and this approach will not be pursued further. This is also due to the fact that cooling frying oil to −4° C. in a running frying system does not seem realistic and would mean high energy consumption.

### 5.3.2 Membrane Selection

With the GMT oNF-1 membrane, no satisfactory results could be achieved during the preliminary tests. Although the retention factor was above the reference value of PERVAP 4060, the low permeate flux puts this into perspective, which is why the membrane is considered unsuitable for further tests. The GMT oNF-3 membrane already showed a satisfactory retention factor in the first test and a permeate flux more than three times higher than the reference value. Thus, no confirmatory experiments were performed and after a run time of two hours, it was decided to further characterize this membrane.

### 5.3.3 PERVAP 4060

The results of the tests are within the expected range. Thus, the assumption that permeate flux decreases with increased TPA_{R} could be confirmed. It could be shown that the retention factor increases with increasing TPA_{R}. These two effects could be due to the increased concentration of PTG. As the PTG concentration increases, the viscosity of the frying oil also increases, which in turn negatively affects the permeate flux and may also increase the retention factor.

The last test run of the experiment from section 4.2.3.1, in which the retentate was replaced with the initial frying oil, again showed an increase in permeate flux in the range expected from the regression line. This confirms the assumption that the decrease in permeate flux depends on the retentate composition and not on fouling.

Sampling during this long-term experiment was carried out at irregular intervals. A more regular sampling in the experimental setup would have been desirable. However, since mainly the influence of the TPA concentration in the retentate was to be assessed, this was neglected for organizational reasons.

5.3.4 GMT oNF-3

The influences of pressure and temperature on permeate flux were within the expected range and tended to behave similarly to those of PERVAP 4060. It is known that permeate flux increases with increasing pressure and decreasing viscosity. Since the viscosity of oil is temperature dependent and decreases with increasing temperature, the increased permeate flux with increasing temperature can be related to the resulting decrease in viscosity. The optimum temperature conditions are therefore probably at the intersection of the two regression lines in FIG. 21.

In the characterization of the flow dependence, the last experiment oNF3-53c4 was stopped after 15 minutes because the temperature development by the pump was so high that constant and thus comparable temperature values could not be maintained. For this reason, the parameters measured in the 15 minutes were extrapolated to one hour. According to the literature, permeate flux should increase with increasing overflow. However, this could not be clearly confirmed by tests.

Tests 53a.1, 53b.2 and 53c. 1 were carried out with exactly the same test conditions and can therefore be compared with each other and used as an indicator of reproducibility. For a better overview, these results are shown in Table 15. The permeate flux values of the three experiments have a standard deviation of 0.13 l/m² h and that of the retention factor a standard deviation of 0.049. In experiment 53c, the TPA_{R} was about 7.5% lower than in 53a and 53b. This explains the higher permeate flux and the lower retention factor. Based on this comparison of results, it is assumed that the membrane performs consistently under the same process conditions.

TABLE 15
The results of experiments 53a.1, 53b.2 and 53c.1 compiled
for comparison of permeate flux and retention factor.

| | TPA Retentate | Permeate flux | Retention |
|---|---|---|---|
| Trial number | [%] | [l/h · m²] | factor |
| 53a.3 | 27.08 | 2.05 | 0.51 |
| 53b.2 | 26.99 | 2.00 | 0.49 |
| 53c.1 | 19.56 | 2.29 | 0.40 |

The viscosity of the medium to be filtered is an important parameter to be determined when designing a membrane filter system. For this reason, viscosity measurements of the retentate were made and plotted over time in FIG. 25. As expected, it increases as the TPA is concentrated. At a TPA value of 51%, it is 35.70 mPa·s. Looking at the PTG, the reason for the increased viscosity becomes clear. While the PTG content at the beginning of the long-term test (viscosity: 24.35 mPas) is still 9.53%, it increases to 27.94% and thus presumably causes the increase in viscosity.

### 5.4 System Design

In the preliminary tests it became clear that the desired part of the frying oil, i.e. the part with the lower TPA, is in the permeate. The difficulty in system design was now to develop a process that would meet these requirements. If the degradation products had been in the permeate and this had had the high TPA content, a simpler process would have been sufficient and continuous removal of the permeate would have been sufficient. However, a system with two circuits had to be developed in order to prevent the retentate with a high concentration of TPA from mixing with the frying oil in the frying tank. However, this more complex system results in the need to use more apparatus such as pumps and valves, making the system more error-prone. For reliable operation of the entire system, it is essential that no solid particles enter the piping system, which could lead to fouling or clogging of valves or pumps. In addition, streams with a solids content tend to stick to surfaces or settle in dead spaces. This underscores that the entire fryer should be of hygienic design. This aims, among other things, to prevent dead spaces and improve food safety. In this regard, special attention should be paid to the seals. Deformations can occur in seals due to pressure and temperature changes, and thus also the dead spaces mentioned. Hygienic design should also be applied to the selection of materials. Physiologically safe materials should be used that do not interact with the food and do not allow substance migration. Examples of such materials are 316L stainless steel, PEEK or PTFE. Contamination of the product, corrosion, contamination and foam formation can thus be prevented.

The heat exchanger in the process is necessary because the membrane system and membranes do not allow temperatures of 170° C. and the possible choice of pumps and other fittings is greater if they have to be designed for lower temperatures. However, cooling should be kept to a minimum and heat recovery should take place to minimize energy consumption.

In order to prevent a constant pressure loss in the membrane filter system and thus save energy, the pressure in the system is maintained with the retention valve (ID: 7.1). Thus, only pump 2 must apply the pressure of 20 bar (at 0.4 l/h). Pump 3, which should have a flow of approx. 170 l/h, can thus be operated without pressure. The heat generated during cross-flow filtration could be dissipated with air cooling in heat exchanger 2.

The control of the drain valve has yet to be defined and should be set so that the TPA concentration in the membrane circuit does not exceed a predetermined value. Based on the long-term test from section 4.2.3.2, this value should be set between 40 and 45% TPA. Above this concentration, the viscosity increases to such an extent that sufficient permeate flux can no longer be guaranteed and the frying oil must be diluted. In addition, it must be remembered that the TPA concentration in the permeate is directly dependent on the TPA concentration in the retentate. In order to still have a positive effect on the oil quality in the fryer with the permeate, the TPA_{P} should not exceed 18%. This would mean that with a filter factor of 0.6, the TPA_{R} must not exceed 45%. This value would have to be monitored with suitable sensors in order to use it to control the valves. Two types of oil drain are conceivable. On the one hand, continuous draining with a defined volume flow as soon as a defined TPA value is reached, or batch-type draining of the entire retentate circuit after the maximum TPA_{R} is reached. These two types are described and discussed in sections 4.4 and 5.5, respectively.

The permeate flux is reheated in heat exchanger 1 and fed back into the fryer. It is important here that the inflow in the frying basin is placed below the oil level so that no additional oxygen contact occurs. This applies to the entire system, which should ideally be completely closed to be protected from light and oxygen.

The system should be designed to make cleaning as easy as possible for food service personnel. To extend the life of the membranes and allow for membrane cleaning, it would be possible to have a replaceable membrane module that can be completely replaced by the service staff to then clean it in-house and replace the membranes as needed. Failure of the fryer during cleaning can thus be avoided.

On the basis of the tests, some transfer criteria could be identified which must be observed for a successful model transfer or change of scale. In order to achieve comparable results in the modified scale, it is important that the two systems have a geometric similarity, i.e. that they are of the same membrane module type. Furthermore, parameters such as TMP, overflow velocity, reset factor and oil temperature should be constant (see also section 5.3). Since the membrane system is a flow-dependent system, the dimensionless Reynolds number should be used and observed for the scale change. However, with the current system, this could only be roughly calculated, since information on the exact masses of the membrane plates was not provided by the manufacturer and is difficult to measure. In microchannels, a flow is considered turbulent if Re>300. The calculated Reynolds number is 0.035 and thus clearly in the laminar range.

### 5.5 Simulation

The simulation proved to be a useful tool for a better understanding of the interrelationships in the entire system. It was found that the membrane area and the permeate flux have a smaller influence on the whole system than initially assumed. In FIG. 29 it could be seen that the membrane area of 0.05 m² would already be sufficient to keep the TPA concentration constant and with an increase of the area no significant improvements could be achieved. This suggests that the continuous draining of old frying oil alone, already has an impact on the lifetime of the frying oil. These points would need to be confirmed in a practical trial.

The curves of the TPA content of the permeate and the fryer equalize over time. This shows the limitation of the system already mentioned in section 5.4. When the TPA concentration in the retentate increases, the TPA concentration in the permeate increases at the same time, since this depends directly on the TPA_{R} and the retention factor. Thus, the retention factor can be regarded as a decisive criterion for continuous membrane filtration in a catering deep fryer.

The comparison of the oil drain types can be performed in a simplified way with the simulation. In the case of continuous drainage, the amount of oil consumption depends strongly on the volume flow. If this is high, the frying oil drain increases, but at the same time the oil quality improves. According to the simulation, a frying oil drain rate of 0.03 l/h at a threshold value of 16% TPA should be sufficient to keep the TPA content in the prototype fryer constant at below 18%.

With the settings shown in FIG. 45, the volume of fresh oil required with the continuous drainage method is around 58 liters. If the batch drain is switched to, the volume of fresh oil required is around 85 liters. However, this is with a better oil quality in the fryer. It should also be noted that with batchwise frying oil drainage, the retentate circuit is drained twice a day from the start. This results in the frying oil of the retentate circuit being discarded despite low TPA concentration. As with continuous draining, a threshold would have to be defined to prevent the draining of (fresh) frying oil.

In order to be able to simulate all influences and thus make optimizations, an extension of the simulation is recommended. A clear user interface with all adjustable parameters would allow efficient work and facilitate the monitoring of all stored data.

5.6 Frying Test with Prototype

### 5.6.1 Experimental Setup

The prototype used differs from the process sketch shown in section 4.3. The first circuit (green) shown in FIG. 26 was not taken into account. Only the membrane filtration circuit was simulated in order to show its effects on an operating fryer in isolation. The first circuit with continuous filtration via the depth filter was considered at the same time. In this way, both circuits can be evaluated independently of each other with regard to their effectiveness.

The comparability of the prototype with the standard fryer was ensured throughout the test by the fact that exactly the same steps were carried out in both fryers. This meant that comparability between the two fryers could be guaranteed even when conditions changed. It should be noted, however, that despite the fact that the frying basins were of the same size, the frying oil/frying material ratio was not the same. The relatively large feed tank in the membrane circuit, which is directly connected to the fryer, increased the effective amount of oil in the entire circuit of the prototype fryer. This may have resulted in slower spoilage in the prototype due to a larger amount of fresh oil. Sampling the prototype fryer basin as well as the retentate circuit removed twice the amount of oil from each of the prototype systems, which had to be replaced with fresh oil. To compensate for this difference from the standard fryer, two samples of 50 ml each were taken from the standard fryer instead of the necessary single sample of 50 ml. However, these large sample volumes meant that the fryers had to be refilled daily with one to two liters of fresh frying oil.

### 5.6.2 Challenges During the Execution of the Experiment

The start of the frying trials had to be postponed several times due to various technical problems. However, useful insights were gained from these problem-solving processes, which is why these challenges and the experience gained from them are discussed here.

The greatest delay was caused by foaming of the frying oil in the prototype fryer, which occurred when the fried food was lowered. Possible causes were particles from the depth filter, the influence of the pump on the water distribution in the frying oil, proteins in the rapeseed oil (caused by wet seeds) and incorrect temperature control. In addition, unsuitable component materials can lead to foam formation, which is why the installed seals and hoses were also counted among the possible causes. These potential triggers were systematically excluded, as noted in the protocol. The seals and hoses were first assessed via the specifications. The pump is only rated for operation at 80° C., but could be ruled out as a cause of foaming. The hoses are approved for foodstuffs up to 250° C. In order to be able to exclude the silicone hoses used as the cause nevertheless, 2 cm of the hose, 300 ml of fresh frying oil was exposed at 100° C. for three hours. After removing the silicone tube, the frying oil was used to fry 100 g of French fries at 170° C. This again led to the known foaming. This again resulted in the known foaming, identifying the hoses as the cause of the foaming. These were then replaced with pure PTFE hoses, which are not optimal in handling, but can withstand the pressure and temperature conditions in the process and are food compliant. However, for another prototype fryer in the future, other hoses should be used or, ideally, stainless steel lines should be installed.

Another challenge identified was ensuring constant pump performance. The pump failed several times due to contamination and had to be opened and cleaned. It was found that during cleaning of the fryer and the associated replacement of the depth filter, solids entered the piping system. These led to contamination of the pump and valves, resulting in a reduction in pump performance. This underlines the importance of prefiltration for a trouble-free process. For further process development, care must therefore be taken to ensure that the depth filter can be replaced without contaminating the lines.

The deterioration of the frying oil was slower than expected for both fryers. As a result, the test design was adjusted for the last three test days in order to bring the frying oil to a TPA of >27% with the available resources. The reason for the slow frying oil deterioration can be attributed to the relatively large sample size (500 ml per fryer per day) and the very heat stable stable HOLL canola oil. The sample quantity had to be balanced with the corresponding quantity of fresh oil. In addition, there was the frying oil discharge through the frying material, which was also compensated with fresh oil.

### 5.6.3 System Parameters of the Membrane System

In section 5.3, system parameters were proposed with which optimal filtration performance should be achieved. However, on the basis of the simulation it could be shown that the permeate flux has a smaller influence on the overall system than initially assumed. For this reason, it was decided to rely on system parameters that put less stress on the membrane and reduce the energy required (see section 3.7). The process was simulated with the selected parameters in advance of the experiments. These showed that the desired frying oil improvement could also be achieved with these system parameters.

The temperature in the feed tank remained stable over the entire test period. However, the pressure drop increased over time and the inlet pressure was increased to 23 bar on test day 11 to maintain a TMP of 20 bar. The overflow could be kept constant at 61/min.

### 5.6.4 Analytics

The focus of the analytical assessment of the two fryers was on the TPA, which is considered a spoilage indicator by the legislator in Switzerland. In this section, the course of the TPA is related to the additional analyses and calculations performed and discussed.

In section 4.5.1.1, it was shown that the increase in TPA of the prototype was lower than that of the standard fryer. This could be quantified with a linear regression line. Experience has shown that the TPA increase is not linear. Nevertheless, coefficients of determination of over 0.84 were achieved, which is sufficient to compare the increases in TPA in both fryers. It can be clearly seen that the prototype can keep the TPA at an acceptable level of <12% even after more than 280 h, while the TPA concentration in the standard fryer rises to over 27% and is thus considered spoiled according to Swiss and European law. This is confirmed when, in addition to TPA, the acid number is also included as an indicator and calculated using Formula 5 of the DEGLEV (See Section 4.5.1.5). While the prototype was still clearly above the threshold of 50 after 295 h, the frying oil of the standard fryer was already considered spoiled after 252 h. If the regression lines of the prototype fryer are extrapolated, the DEGLEV would only fall below the threshold value of 50 after 644 h (27 days) and the TPA would only be above the threshold value of 27% after 1014 h (42 days).

In the simulated process, the fryer reaches a TPA of around 15% after 300 h (See section 4.4). This is a higher value than the TPA values of 11.84% after 295 h measured during the trial (See section 4.5.1.1), which indicates that the goal of a constant frying oil quality is achievable. However, the question still remains why the TPA_{R} increases to a maximum of 13.35% during the test and is thus also significantly lower than the TPA in the standard fryer. Based on the simulation, this should have risen to around 30% TPA. A possible reason for the low value could be that reaction products, which catalyze the frying oil spoilage, are reduced by the membrane filtration and thus slow down the oil spoilage.

The anisidine number can be used to estimate the oxidative degradation. The samples measured in section 4.5.1.3 show a higher anisidine number in the standard fryer than in the prototype right from the start. The slightly higher slope of the regression line of the standard fryer also suggests a faster oxidative decay. However, the coefficient of determination of this regression line is rather low (R²=0.681). The residual of the measurements also shows a comparatively high value, which suggests that the measured spectra do not correspond to the calibration spectra and therefore measurement inaccuracies may occur. Thus, a reliable statement about the oxidative differences in the two fryers is difficult to make.

The PTGs increase over time, as listed in section 4.5.1.4, and can thus influence the viscosity of the frying oil. This could be confirmed with the measurements carried out in section 4.5.3. However, the differences in viscosity between prototype and standard are rather small with 0.4 mPa's while the PTG show significant differences. From experience, the viscosity should have an influence on the permeaflux. This decreases during the course of the experiment, as shown in section 4.5.2, but settles at 1.07 l/h m² after about 175 h. The curves of viscosity and permeate flux suggest that the decrease in permeate flux is not solely dependent on viscosity, but that the fouling of the lines described in section 5.6.2 may also have affected the membranes, leading to increased fouling and a decrease in permeate flux.

The color of the frying oil is considered to be another indicator of its spoilage, used mainly in the catering industry. However, the color difference ΔE*ab only indicates the difference between two samples, but does not provide any information about the nature of the difference. A ΔE*ab value of 1 is considered a difference no longer visible to the eye. A ΔE*ab value of 10 or more, on the other hand, suggests that different colors are involved. Thus, the color difference in section 4.5.3 showed that this value is already exceeded after the first day of the test and that there are clear differences between the two oils.

Since the discoloration of frying oil is usually a brown discoloration, the BI gives a good indication for comparing the two frying oils with regard to their spoilage. At the end of the experiment, the frying oil of the prototype has a BI of 0.18, which is 21.37 lower than the frying oil of the standard fryer. Thus, the BI could clarify the color difference and confirmed that it was a change in brown coloration. The L* value of the prototype at the end of the tests is 12.9 units higher than that of the standard fryer, which additionally indicates a darkening of the frying oil.

The in-out tests on test day 1 and 11 could not be performed due to an insufficient number of testers and are therefore missing in section 4.5.5. The DEGLEV, as described in section 1.5, is used to determine the sensory spoilage of the frying oil and is based on the correlation of analytical values and a binary in-out test. The results of the tests described in section 4.5.5 should therefore come to the same conclusion as the results of the DEGLEV. According to the latter, the frying oil of the standard fryer should already have been judged as “out” on day 12. However, the testers did not rate the frying oil of the standard fryer as spoiled until day 13. It should be noted that more intensive training of the testers as well as a higher number of testers should be aimed for in the future, which could lead to more accurate results.

By evaluating the frying oil and the French fries, it was also found that a frying oil rated as “out” did not directly result in an “out” rating for the fried food. The French fries were rated “in” throughout the experiment. The profile data from the descriptive in-out test should be considered as additional information and should not replace or relativize the in-out decision. Nevertheless, they provide valuable information on the various attributes. For example, a fishy odor was perceived in the frying oil of the standard fryer during the first days of the test, the origin of which could not yet be clarified and should be kept in mind for future tests. It was also found that the french fries of the prototype tended to be perceived as lighter in color than those of the standard fryer.

### 5.7 Risks

As previously addressed, the entire process is designed around the GMT membrane, which poses a significant risk. Membrane selection would have to be started over if it could not be used due to lack of declarations of compliance. For this reason, this risk received three points in severity of impact. The probability is rated with the highest score, because the declaration of conformity from the manufacturer would mean a large financial effort, and after initial discussions no clear tendency could be recognized that the company GMT is willing to take on this effort and thus also the risk.

The greatest risks were identified in the risk dimensions “economy” and “technology”. In addition to the technical challenges, the economic viability of the new development must be ensured for Gastrofrit, but also for its customers. In order to minimize the risks in the technical dimension, it will be decisive which materials or components can be installed. Here, for example, the temperature condition will be a limiting and decisive factor. Particularly in the technical dimension, the risk analysis should be expanded in cooperation with the relevant industry partners.

A risk analysis should always be carried out with all project partners involved, as otherwise certain perspectives could be disregarded. For this reason, the risk analysis carried out should not be regarded as conclusive, but rather as a basis for a risk analysis within the OLFO project team. By defining so-called “showstoppers”, the point in time should be defined at which the continuation of the project should be questioned. If a risk in a phase is judged to be too high or the costs to mitigate this risk are judged to be not economical, the project can be stopped with less loss of resources or countermeasures can be taken.

### 6 Conclusion

Previous studies and internal trials have already shown that membrane filtration can be used to reduce TPA in frying oil. Until now, however, the low permeate flux was always listed as a hurdle for commercial use. The choice of lipophilic NF membranes suitable for edible oil is very limited. For example, the GMT oNF-3 membrane used is not yet approved for use in foodstuffs and has yet to be declared suitable for foodstuffs through conformity work.

Compared to previous experiments, the permeate flux could be increased in this work and with the developed filtration system it was shown how a membrane with a nevertheless rather low permeate flux, can successfully contribute to a significant improvement of the frying oil quality of a gastronomy fryer. Most spoilage-indicating parameters indicated a significant improvement in frying oil quality in the prototype compared to the standard fryer. Although the oil-to-product ratio of the compared fryers was not identical, it can be assumed that this is not the sole reason for the observed improvement and that membrane filtration provides a meaningful benefit.

The tests were designed to ensure a consistent and good frying oil quality in the prototype fryer and provided promising results in this regard. However, it should be noted that the ultimate goal of the fryer purchaser is to reduce the amount of frying oil used. With the developed system, frying oil still has to be disposed of from the retentate, so oil waste cannot be completely avoided. For acceptance by the purchaser, it will be important how much frying oil can be saved compared to a normal fryer. The effective oil saving that can be achieved depends, for example, on the volume of the membrane circuit, the retention factor and the amount of oil drainage, and should be taken into account in the final design of the OLFO fryer. The savings can be estimated by simulation. Compared to the standard fryer, a reduction in oil drain of about 50% can be expected.

Nevertheless, this is a first prototype and the first practical frying test. The positive effects such as the slowing down of the TPA increase, the color improvement and the reduction of the PTG must be confirmed experimentally with further trials. For this purpose, it is advisable to carry out these tests already with a next prototype generation in order to get closer to the conditions of the final OLFO fryer. For example, the entire system would have to be closed and the amount of frying oil in the membrane circuit reduced to one liter. The sensory characteristics of the products, especially the fishy odor, should be further monitored in field tests during this process. The prefiltration can be evaluated on the basis of the bachelor thesis running parallel to this work and can be of importance for further development.

For the further steps of the fryer development, the missing factors such as the configuration of the membrane elements, should be worked out with external experts. For example, the external support of a membrane module manufacturer, such as BMT, would be recommended. In this way, further work can be done on the prototype and the system design can be re-evaluated until implementation and initial field tests in the catering industry are possible.

The factor of most concern in the risk analysis, the declaration of conformity for the membrane used, should be clarified promptly in order to be able to plan the further procedure. In case of rejection, cooperation with the membrane manufacturer could be sought in order to perform the conformity work in cooperation and to reduce the effort for GMT.

Finally, it can be stated that the development of the OLFO fryer is on a good path and the continuation of the research work is recommended. Here it is important to acquire the appropriate expertise for the design team. In this way, optimal conditions can be created to launch an environmentally friendly, innovative and customer-oriented product that exceeds customer expectations and enables simple, safe and cost-efficient deep-frying.

The invention can be summarized by the following feature sets.
1. A frying apparatus, said frying device comprising a housing defined by outer walls and a container adapted to contain a liquid, said liquid preferably being an oil, said frying device being connected to a filtration system, said filtration system being configured to continuously receive and return a flow of said liquid to said container in a closed loop configuration, said container comprising at least one depth filter and/or pre-filter, said filtration system comprising first and second filter circuits.
2. The frying apparatus of feature set 1, wherein the first filter circuit comprises fluid-carrying tubing and at least one pump for pumping the fluid and is configured to flow the stream of fluid through the depth filter and/or prefilter.
3. The frying apparatus of feature set 2, wherein the second filter circuit comprises fluid-carrying hoses, at least two pumps, and a filter element, wherein the fluid-carrying hoses of the second filter circuit are connected to the first filter circuit such that a partial flow of the flow of the first filter circuit is directed as a flow into the second filter circuit.
4. The frying apparatus of feature set 3, wherein the partial flow is delivered to the second filter circuit by the first pump of the second filter circuit.
5. The frying apparatus of feature set 4, wherein during operation downstream of the first pump of the second filter circuit there is an increased pressure compared to upstream of the first pump of the second filter circuit by at least 18 bar, preferably at least 20 bar, or preferably at least 22 bar, or preferably at least 24 bar, most preferably at least 25 bar.
6. The frying apparatus of feature set 5, wherein the flow of the fluid after the first pump of the second filter circuit is pumped through the filter element by means of the second pump of the second filter circuit.
7. The frying apparatus of feature set 6, wherein the filter element of the second filter circuit is a membrane filter.
8. The frying apparatus according to any one of feature sets 3 to 7, wherein the second pump of the second filter circuit pumps the liquid conduit through the membrane filter so that the flow of the liquid creates an overflow and an underflow in the membrane filter, the overflow and the underflow being separated by a membrane cloth, the underflow being a closed circuit, thereby creating a permeate and a retentate.
9. The frying apparatus of feature set 8, wherein the permeate, through a third pump of the second filter circuit, is returned to the tank.
10. The frying apparatus according to any one of feature sets 1 to 9, wherein the second filter circuit comprises a heat exchanger, the heat exchanger being configured to cool the flow of liquid downstream of the first and upstream of the second pump of the second filter circuit to at least below 170° C., preferably to below 140° C., more preferably to below 110° C.
11. The frying apparatus of feature set 10, wherein the heat exchanger comprises a conventional heater, wherein the conventional heater is optionally a silicone heater.
12. The frying apparatus according to any one of feature sets 10 or 11, wherein the heat exchanger is configured to heat the permeate downstream of the membrane filter and prior to entering the vessel.
13. The frying apparatus according to any of feature sets 1 to 12, wherein the filter system is arranged inside the housing and, optionally, is protected from light.
14. The frying apparatus according to any of feature sets 1 to 12, wherein the filter system is arranged outside the housing and, optionally, is protected from light.
15. A method for filtering oil in the frying apparatus according to feature sets 7 to 14, wherein the liquid is continuously pumped or sucked through the membrane filter.

It should be appreciated that the particular implementations shown and herein described are representative of the invention and its best mode and are not intended to limit the scope of the present invention in any way.

It should be appreciated that many applications of the present invention can be realized.

As will be recognized by those skilled in the art, the present invention may be embodied as a system, apparatus or method.

Moreover, the system contemplates the use, sale and/or distribution of any goods, services or information having similar functionality described herein.

The specification and figures should be considered in an illustrative manner, rather than a restrictive manner, and all modifications described herein are intended to be included within the scope of the invention claimed. Accordingly, the scope of the invention should be determined by the appended claims (as they currently exist or as later amended or added, and their legal equivalents) rather than by merely the examples described above. Steps recited in any method or process claims, unless otherwise expressly stated, may be executed in any order and are not limited to the specific order presented in any claim. Further, the elements and/or components recited in apparatus claims may be assembled or otherwise functionally configured in a variety of permutations to produce substantially the same result as the present invention. Consequently, the invention should not be interpreted as being limited to the specific configuration recited in the claims.

Benefits, other advantages and solutions mentioned herein are not to be construed as critical, required or essential features or components of any or all the claims.

As used herein, the terms “comprises”, “comprising”, or variations thereof, are intended to refer to a non-exclusive listing of elements, such that any apparatus, process, method, article, or composition of the invention that comprises a list of elements, that does not include only those elements recited, but may also include other elements such as those described in the instant specification. Unless otherwise explicitly stated, the use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or adapted by the skilled artisan to other designs without departing from the general principles of the invention.

The patents and articles mentioned above are hereby incorporated by reference herein, unless otherwise noted, to the extent that the same are not inconsistent with this disclosure.

Other characteristics and modes of execution of the invention are described in the appended claims.

Further, the invention should be considered as comprising all possible combinations of every feature described in the instant specification, appended claims, and/or drawing figures that may be considered new, inventive and industrially applicable.

Additional features and functionality of the invention are described in the claims appended hereto and/or in the abstract. Such claims and/or abstract are hereby incorporated in their entirety by reference thereto in this specification and should be considered as part of the application as filed.

Multiple variations and modifications are possible in the embodiments of the invention described here. Although certain illustrative embodiments of the invention have been shown and described here, a wide range of changes, modifications, and substitutions is contemplated in the foregoing disclosure. While the above description contains many specific details, these should not be construed as limitations on the scope of the invention, but rather exemplify one or another preferred embodiment thereof. In some instances, some features of the present invention may be employed without a corresponding use of the other features. Accordingly, it is appropriate that the foregoing description be construed broadly and understood as being illustrative only, the spirit and scope of the invention being limited only by the claims that ultimately issue in this application.

1. A frying apparatus, said frying apparatus comprising a housing defined by outer walls and a container adapted to contain a liquid, said liquid preferably being an oil, said frying apparatus being connected to a filtration system, said filtration system being configured to continuously receive and return a flow of said liquid to said container in a closed loop configuration, said container comprising at least one depth filter and/or pre-filter, said filtration system comprising first and second filter circuits.

2. The frying apparatus of claim 1, wherein the first filter circuit comprises fluid-carrying tubing and at least one pump for pumping the fluid and is configured to flow the stream of fluid through the depth filter and/or prefilter.

3. The frying apparatus of claim 2, wherein the second filter circuit comprises fluid-carrying hoses, at least two pumps, and a filter element, wherein the fluid-carrying hoses of the second filter circuit are connected to the first filter circuit such that a partial flow of the flow of the first filter circuit is directed as a flow into the second filter circuit.

4. The frying apparatus of claim 3, wherein the partial flow is delivered to the second filter circuit by the first pump of the second filter circuit.

5. The frying apparatus of claim 4, wherein during operation downstream of the first pump of the second filter circuit there is an increased pressure compared to upstream of the first pump of the second filter circuit by at least 18 bar, preferably at least 20 bar, or preferably at least 22 bar, or preferably at least 24 bar, most preferably at least 25 bar.

6. The frying apparatus of claim 5, wherein the flow of the fluid downstream of the first pump of the second filter circuit is pumped through the filter element by means of the second pump of the second filter circuit.

7. The frying apparatus of claim 6, wherein the filter element of the second filter circuit is a membrane filter.

8. The frying apparatus of claim 3, wherein the second pump of the second filter circuit pumps the liquid conduit through the membrane filter such that the flow of the liquid creates an overflow and an underflow in the membrane filter, the overflow and the underflow being separated by a membrane cloth, the underflow being a closed loop, thereby creating a permeate and a retentate.

9. The frying apparatus of claim 8, wherein the permeate, through a third pump of the second filter circuit, is returned to the vessel.

10. The frying apparatus of claim 1, wherein the second filter circuit comprises a heat exchanger, the heat exchanger being configured to cool the flow of liquid downstream of the first and upstream of the second pump of the second filter circuit to at least below 170° C., preferably to below 140° C., more preferably to below 110° C.

11. The frying apparatus of claim 10, wherein the heat exchanger comprises & conventional heater, wherein the conventional heater is optionally a silicone heater.

12. The frying apparatus of claim 10, wherein the heat exchanger is configured to heat the permeate after the membrane filter and before entering the vessel.

13. The frying apparatus of claim 1, wherein the filter system is arranged inside the housing and, optionally, is protected from light.

14. The frying apparatus of claim 1, wherein the filter system is arranged outside the housing and, optionally, is protected from light.

15. The method of filtering oil in the frying apparatus according to claim 7, wherein the liquid is continuously pumped or sucked through the membrane filter.

16. The frying apparatus of claim 4, wherein the second pump of the second filter circuit pumps the liquid conduit through the membrane filter such that the flow of the liquid creates an overflow and an underflow in the membrane filter, the overflow and the underflow being separated by a membrane cloth, the underflow being a closed loop, thereby creating a permeate and a retentate.

17. The frying apparatus of claim 5, wherein the second pump of the second filter circuit pumps the liquid conduit through the membrane filter such that the flow of the liquid creates an overflow and an underflow in the membrane filter, the overflow and the underflow being separated by a membrane cloth, the underflow being a closed loop, thereby creating a permeate and a retentate.

18. The frying apparatus of claim 6, wherein the second pump of the second filter circuit pumps the liquid conduit through the membrane filter such that the flow of the liquid creates an overflow and an underflow in the membrane filter, the overflow and the underflow being separated by a membrane cloth, the underflow being a closed loop, thereby creating a permeate and a retentate.

19. The frying apparatus of claim 7, wherein the second pump of the second filter circuit pumps the liquid conduit through the membrane filter such that the flow of the liquid creates an overflow and an underflow in the membrane filter, the overflow and the underflow being separated by a membrane cloth, the underflow being a closed loop, thereby creating a permeate and a retentate.

20. The frying apparatus of claim 2, wherein the second filter circuit comprises a heat exchanger, the heat exchanger being configured to cool the flow of liquid downstream of the first and upstream of the second pump of the second filter circuit to at least below 170° C., preferably to below 140° C., more preferably to below 110° C.
